(19) United States
(12) Patent Application Publication
(10) Pub. No.: US 2004/0095478 A1
(43) Pub. Date: May 20, 2004

(54) Image-capturing apparatus, image-processing apparatus, image-recording apparatus, image-processing method, program of the same and recording medium of the program

(75) Inventors: Hiroaki Takano, Tokyo (JP); Tsukasa Ito, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: KONICA MINOLTA HOLDINGS, INC., Tokyo (JP)

(21) Appl. No.: 10/712,889

(22) Filed: Nov. 12, 2003

(30) Foreign Application Priority Data
Nov. 20, 2002 (JP) JP2002-337168

(51) Int. Cl. H04N 9/73; H04N 5/76

(52) U.S. Cl. 348/223.1; 348/231.6

(57) ABSTRACT

There is described an image-capturing apparatus, which stores digital image data without losing captured image information and applies a white-balance adjustment reflecting tastes of the photographer onto the digital image data. The apparatus includes: a scene-referred raw data generating section to generate scene-referred raw data, which directly represent the image while depending on image-capturing characteristics of the apparatus; a reproduction-auxiliary data generating section to generate reproduction-auxiliary data, based on which an image-capturing characteristic compensation processing is to be applied to the scene-referred raw data, so as to generate scene-referred image data in a standardized format from the scene-referred raw data; a designating section to designate a degree of white-balance adjustment; and a storage controlling section to attach the reproduction-auxiliary data and white-balance data indicating the degree of the white-balance adjustment to the scene-referred raw data in order to store all of them into a storage medium.

### BACKGROUND OF THE INVENTION

The present invention relates to an image-capturing apparatus such as a digital camera, an image processing method for optimizing an image quality of a visual image formed on an outputting medium in respect to digital image data obtained by such the image-capturing apparatus, an image-processing apparatus employing the abovementioned image processing method, an image-recording apparatus that forms an visual image on the outputting medium by employing the abovementioned image processing method, a computer program for executing the abovementioned image processing method and a recording medium that stores the computer program and is readable by an computer.

At present, the digital image data captured by an image-capturing apparatus is distributed through such a memory device as a CD-R (Compact Disk Recordable), floppy disk (registered trade name) and memory card or the Internet, and is displayed on such a display monitor as a CRT (Cathode Ray Tube), liquid crystal display and plasma display or a small-sized liquid crystal monitor display device of a cellular phone, or is printed out as a hard copy image using such an output device as a digital printer, inkjet printer and thermal printer. In this way, display and print methods have been diversified in recent years.

When digital image data is displayed and output for viewing, it is a common practice to provide various types of image processing typically represented by gradation adjustment, brightness adjustment, color balancing and enhancement of sharpness to ensure that a desired image quality is obtained on the display monitor used for viewing or on the hard copy.

In response to such varied display and printing methods, efforts have been made to improve the general versatility of digital image data captured by an image-capturing apparatus. As part of these efforts, an attempt has been made to standardize the color space represented by digital RGB (Red, Green and Blue) signals into the color space that does not depend on characteristics of an image-capturing apparatus. At present, large amounts of digital image data have adopted the sRGB (See Multimedia Systems and Equipment—Color Measurement and Management—Part 2-1: Color Management—Default RGB Color Space—sRGB” IEC61966-2-1) as a standardized color space. The color space of this sRGB has been established to meet the color reproduction area for a standard CRT display monitor.

Generally, a digital camera is equipped with an image-capturing device (CCD type image-capturing device, hereinafter referred to simply as “CCD”) having a photoelectric conversion function with color sensitivity provided by a combination of a CCD (charge coupled device), a charge transfer device and a mosaic color filter. The digital image data output from the digital camera is obtained after the electric original signal gained by conversion via the CCD has been corrected by the photoelectric conversion function of the image capturing device, and processing of file conversion and compression into the predetermined data format standardized to permit reading and display by image editing software.

Correction by the photoelectric conversion function of the image capturing device includes, for example, gradation correction, spectral sensitivity, cross-talk correction, dark current noise control, sharpening, white balance adjustment and color saturation adjustment. The above-mentioned standardized data format widely known includes Baseline Tiff Rev. 6.0 RGB Full Color Image adopted as a non-compressed file of the Exif (Exchangeable Image File Format) file and compressed data file format conforming to the JPEG format.

The Exif file conforms to the above-mentioned sRGB, and the correction of the photoelectric conversion function of the above-mentioned image-capturing element is established so as to ensure the most suitable image quality on the display monitor conforming to the sRGB.

For example, if a digital camera has the function of writing into the header of the digital image data the tag information for display in the standard color space (hereinafter referred to as “monitor profile”) of the display monitor conforming to the sRGB signal, and accompanying information indicating the device dependent information such as the number of pixels, pixel arrangement and number of bits per pixel as meta-data as in the case of Exif format, and if only such a data format is adopted, then the tag information can be analyzed by the image edit software (e.g. Photoshop by Abode for displaying the above-mentioned digital image data on the digital display monitor, conversion of the monitor profile into the sRGB can be prompted, and modification can be processed automatically. This capability reduces the differences in apparatus characteristics among different displays, and permits viewing of the digital image data photographed by a digital camera under the optimum condition.

In addition to the above-mentioned information dependent on device type, the above-mentioned accompanying information includes;

information directly related to the camera type (device type) such as a camera name and code number,

information on photographing conditions such as exposure time, shutter speed, f-stop number (F number), ISO sensitivity, brightness value, subject distance range, light source, on/off status of a stroboscopic lamp, subject area, white balance, zoom scaling factor, subject configuration, photographing scene type, the amount of reflected light of the stroboscopic lamp source and color saturation for photographing, and tags (codes) for indicating the information related to a subject. The image edit software and output device have a function of reading the above-mentioned accompanying information and making the quality of hardware image more suitable.

The image displayed on such a display device as a CRT display monitor and the hard copy image printed by various printing devices have different color reproduction areas depending on the configuration of the phosphor or color material to be used. For example, the color reproduction area of the CRT display monitor corresponding to the sRGB standard space has a wide bright green and blue area. It contains the area that cannot be reproduced by the hard copy formed by a silver halide photographic printer, inkjet printer and conventional printer. Conversely, the cyan area of the conventional printing or inkjet printing and the yellow area of the silver halide photographic printing contain the area that cannot be reproduced by the CRT display monitor corresponding to the sRGB standard color space. (For example, see “Fine imaging and digital photographing” edited by the Publishing Commission of the Japan Society of Electrophotography, Corona Publishing Co., P. 444). In the meantime, some of the scenes of the subject to be photographed may contain the color in the area that cannot be reproduced in any of these areas for color reproduction.

As described above, the color space (including the sRGB) optimized on the basis of display and printing by a specific device is accompanied by restrictions in the color gamut where recording is possible. So when recording the information picked up by a photographing device, it is necessary to make adjustment of mapping by compressing the information into the color gamut where recording is allowed. The simplest way is provided by clipping where the color chromaticity point outside the color gamut where recording is possible is mapped onto the boundary of the nearest color gamut. This causes the gradation outside the color gamut to be collapsed, and the image will give a sense of incompatibility to the viewer. To avoid this problem, non-liner compression method is generally used. In this method, the chromaticity point in the area where chroma is high in excess of an appropriate threshold value is compressed smoothly according to the size of the chroma. As a result, chroma is compressed and recording is carried out even at the chromaticity point inside the color gamut where recording is possible. (For the details of the procedure of mapping the color gamut, see “Fine imaging and digital photographing” edited by the Publishing Commission of the Japan Society of Electrophotography, Corona Publishing Co., P. 447, for example).

The image displayed on such a display device as a CRT display monitor, the hard copied image printed by various types of printing devices, or color space (including sRGB) optimized on the basis of display and printing by these devices are restricted to the conditions where the area of brightness that allows recording and reproduction is of the order of about 100 to 1. By contrast, however, the scene of the subject to be photographed has a wide area of brightness, and it often happens that the order of several thousands to 1 is reached outdoors. (See “Handbook on Science of Color, New Version, 2nd Print” by Japan Society for Science of Colors, Publishing Society of the University of Tokyo, P. 926, for example). Accordingly, when recording the information gained by the image capturing device, compression is also necessary for brightness. In this processing, adequate conditions must be set for each image in conformity to the dynamic range of the scene to be photographed, and the range of brightness for the main subject in the scene to be photographed.

However, when compression has been carried out for the color gamut and brightness area as described above, information on gradation prior to compression or information prior to clipping is lost immediately due to the principle of the digital image to be recorded in terms of the discrete value. The original state cannot be recovered. This imposes a big restriction on the general versatility of high-quality digital image.

For example, when the image recorded in the sRGB standard color space is printed, mapping must be carried out again based on the differences between the sRGB standard color space and the area for color reproduction of the printing device. For the image recorded in the sRGB standard color space, however, the information on gradation in the area compressed at a time of recording is lost. So the smoothness of gradation is deteriorated as compared to the case where the information captured by the photographing device is mapped directly in the area for color reproduction of the printing device. Further, if gradation compression conditions are not adequate at a time of recording, and there are problems such as a whitish picture, dark face, deformed shadow and conspicuous white skipping in the highlighted area, improvement is very inadequate as compared to the case where the new image is created again from the information gained by the photographing device, even if the gradation setting is changed to improve the image. This is because information on gradation prior to compression, and information on the portion subjected to deformation or white skipping have been already lost.

As a solution of the above-mentioned problems, the art of storing the process of image editing as a backup data and returning it to the state prior to editing whenever required has long been known. For example, Patent Document 1 (listed later) discloses a backup device wherein, when the digital image is subjected to local modification by image processing, the image data on the difference between the digital image data before image processing and that after image processing is saved as backup data. Patent Document 2 (listed later) discloses a method for recovering the digital image data before editing, by saving the image data on the difference between the digital image data before image processing and that after image processing. The technologies, set forth in Patent Document 1 and Patent Document 2, are effective from the viewpoint of preventing information from being lost, but the number of sheets that can be photographed by a camera is reduced with the increase in the amount of data recorded in the media.

Other than the image recording in the sRGB standard color space mentioned above, an automatic white-balance adjustment would be cited as an processing including a compression of the subject information at the time of the recording. Conventional digital camera requires cumbersome operations for adjusting frame by frame according to the manual compensating function in order to apply the white-balance adjustment. Accordingly, it has been impossible to appropriately reflect the photographer's tastes onto the reproduced image.

To overcome the abovementioned problem, a digital camera that can select a color tone converting means for outputting an image having a color tone just same as the photographer's perception by considering the adaptability of human's eyes, or another color tone converting means for outputting an image having a color tone under the daylight source, is set forth in Patent Document 3. Further, a digital camera that can omit the cumbersome adjusting operations by making it possible for the photographer to select a degree of the white-balance adjustment is set forth in Patent Document 4. There are many cases that the tastes for finished color tones just same as the viewer's perception and under the daylight source with respect to various light sources, such as a sunset light, a tungsten light, a candle light, etc., would vary among the photographer just capturing the image, a person creating a print of the image and viewers of the image. In addition, the light source at the time of the image-capturing is not limited to a single kind of light source, but there are many cases that a mixed light mixed with two or more than two different kinds of light sources is employed for the image-capturing operation, and therefore, an accurate white-balance adjustment is not always applied.

On the other hand, a method for adjusting the white balance, in which a captured image is divided into small image areas, and the small image areas are grouped into plural groups for every same color temperature, namely every same photographic light source, by creating a histogram of estimated color temperature for every small image area, and then, the white balance is adjusted for a respective one of the plural groups, is set forth in Patent Document 5. However, since, in the information to which the white-balance adjustment processing was already applied at the time of the image-capturing operation, either B-information or R-information already processed with a heavy compression processing, only an insufficient improvement could be achieved even if the digital image data, to which the white-balance adjustment was once applied, is intended to readjust.

The problems introduced above are caused by the procedure where the information on the wide color gamut and brightness area gained by a photographing device is recorded after having being compressed into the output-referred image data in the state optimized by assuming an image to be viewed. By contrast, if the information on the wide color gamut and brightness area gained by a photographing device is recorded as scene-referred image data that is not compressed, then inadvertent loss of information can be prevented. The standard color space suited to record such scene-referred image data is proposed, for example, by RIMM RGB (Reference Input Medium Metric RGB) and ERIMM RGB (Extended Reference Input Medium Metric RGB). (See the Journal of Imaging Science and Technology, Vol. 45 p p. 418 to 426 (2001)).

However, the data expressed in the standard color space like the one described above, is not suitable for being displayed directly on the display monitor and viewed. Generally, a digital camera has a built-in display monitor or is connected to it in order for the user to check the angle of view before photographing or to check the photographed image after photographing. When photographed data is recorded as output referred image data like the sRGB, it can be displayed directly on the display monitor, without the data being converted. Despite this advantage, when the photographed data is recorded as scene-referred image data, the data must be subjected to the processing of re-conversion into the output-referred image data in order to display that data. Such double processing of conversion inside the camera increases the processing load and power consumption, and causes the continuous shooting capability to be reduced, and imposes restrictions on the number of sheets to be shot in the battery mode.

To solve the abovementioned problems, Patent Document 6 discloses an image processing apparatus characterized by two modes; a mode of recording in the form of an image signal displayed on the display means and a mode of recording in the form of captured image signal. The form of image signal in the latter case is generally called RAW data. Using the special-purpose application software (called “development software”), such digital image data can be converted into output-referred image data of the above-mentioned Exif file or the like for display or printing (called “electronic development” or simply “development”).

Patent Document 1: Tokkaihei 7-57074

Patent Document 2: Tokkai 2001-94778

Patent Document 3: Tokkaihei 10-4458

Patent Document 4: Tokkai 2002-218495

Patent Document 5: Tokkai 2002-271638

Patent Document 6: Tokkaihei 11-261933

Since the RAW data retains all information at a time of photographing, it permits output-referred image data to be remade. If other color system files such as CMYK are created directly, there will no inadvertent modification of the color system due to the difference in color gamut from the display monitor (sRGB). However, the RAW data is recorded according to the color space based on the spectral sensitivity characteristics inherent to the type of a photographing apparatus and the file format inherent to the type of a photographing apparatus. Accordingly, image suitable to display and printing can be obtained only when special-purpose development software inherent to the type of the photographing apparatus is used. Further, it is impossible to conduct the white-balance adjustment, which reflects the tastes of the photographer, with respect to the RAW data as it is.

### SUMMARY OF THE INVENTION

To overcome the abovementioned drawbacks in conventional image-processing apparatus, image-processing methods and image-recording apparatus, it is an object of the present invention to provide an image-capturing apparatus, which makes it possible to store digital image data by employing a general purpose method without losing captured image information and to apply a white-balance adjustment reflecting tastes of the photographer onto the digital image data, and to provide a novel environment for processing a high quality image by employing the abovementioned image-capturing apparatus and the digital image data stored in it.

Accordingly, to overcome the cited shortcomings, the abovementioned object of the present invention can be attained by image-capturing apparatus, image-processing apparatus, image-processing methods and image-recording apparatus described as follow.

(1) An apparatus for capturing an image, comprising: a scene-referred raw data generating section to generate scene-referred raw data, which directly represent the image while depending on image-capturing characteristics of the apparatus; a reproduction-auxiliary data generating section to generate reproduction-auxiliary data, based on which an image-capturing characteristic compensation processing is to be applied to the scene-referred raw data generated by the scene-referred raw data generating section, so as to generate scene-referred image data in a standardized format from the scene-referred raw data; a designating section to designate a degree of white-balance adjustment; and a storage controlling section to attach the reproduction-auxiliary data and white-balance data indicating the degree of the white-balance adjustment to the scene-referred raw data in order to store all of them into a storage medium.

(2) The apparatus of item 1, further comprising: an image-capturing data generating section to generate image-capturing data, which represent image-capturing conditions established at a time of capturing the image; wherein the storage controlling section attaches the reproduction-auxiliary data, the white-balance data and the image-capturing data to the scene-referred raw data in order to store all of them into the storage medium.

(3) The apparatus of item 1, wherein the image-capturing data includes a photographing EV value established at a time of capturing the image.

(4) An apparatus for processing data, comprising: a receiving section to receive scene-referred raw data, which directly represent an image captured by an image-capturing apparatus while depending on image-capturing characteristics of the image-capturing apparatus, and to receive reproduction-auxiliary data in respect to the scene-referred raw data, and to receive white-balance data indicating a degree of white-balance adjustment; a scene-referred image data generating section to generate scene-referred image data from the scene-referred raw data received by the receiving section, based on the reproduction-auxiliary data received by the receiving section, by applying an image-capturing characteristic compensation processing to the scene-referred raw data; and an output data generating section to generate output data by attaching the white-balance data to the scene-referred image data.

(5) The apparatus of item 4, wherein the scene-referred image data are generated in a standardized format from the scene-referred raw data.

(6) The apparatus of item 4, wherein the receiving section also receives image-capturing data, which represent image-capturing conditions established at a time of capturing the image; and wherein the output data generating section generates the output data by attaching the white-balance data and the image-capturing data to the scene-referred image data.

(7) The apparatus of item 5, further comprising: an output-referred image data generating section to generate output-referred image data, based on which a reproduced image is formed on an outputting medium, by applying an image-processing for optimizing the reproduced image to the scene-referred image data generated by the scene-referred image data generating section; wherein contents of the image-processing are determined on the basis of the white-balance data received by the receiving section.

(8) The apparatus of item 6, further comprising: an output-referred image data generating section to generate output-preferred image data, based on which a reproduced image is formed on an outputting medium, by applying an image-processing for optimizing the reproduced image to the scene-referred image data generated by the scene-referred image data generating section; wherein contents of the image-processing are determined on the basis of the white-balance data and the image-capturing data, both received by the receiving section.

(9) The apparatus of item 4, wherein the receiving section receives a photographing EV value established at a time of capturing the image.

(10) The apparatus of item 7, further comprising: an applying amount determining section to determine an applying amount of the white-balance adjustment to be applied to the scene-referred image data, based on the white-balance data indicating the degree of the white-balance adjustment; wherein the output-referred image data generating section includes: a white-balance adjusting section to apply the applying amount of the white-balance adjustment, determined by the applying amount determining section, to the scene-referred image data.

(11) The apparatus of item 10, wherein the white-balance adjusting section is provided with an image area dividing function for dividing a whole image area of the scene-referred image data into a plurality of small image areas.

(12) The apparatus of item 11, wherein the white-balance adjusting section is further provided with a ratio calculating function for calculating a R/G ratio and a B/G ratio for a respective one of the plurality of small image areas, divided by the image area dividing function; and wherein the R/G ratio represents a ratio between an integrated value of R (Red) signals and another integrated value of G (Green) signals within each of the plurality of small image areas, while the B/G ratio represents a ratio between an integrated value of B (Blue) signals and another integrated value of G (Green) signals within each of the plurality of small image areas.

(13) The apparatus of item 12, wherein the white-balance adjusting section is further provided with a light-source estimating function for estimating a kind of a photographic light source for a respective one of the plurality of small image areas, by plotting the R/G ratio and the B/G ratio, calculated by the ratio calculating function, onto a light-source estimating map in which light-source area frames, indicating ranges of various combinations of the R/G ratio and the B/G ratio corresponding to various kinds of light-sources.

(14) The apparatus of item 13, wherein the white-balance adjusting section is further provided with a light-source determining function for determining a kind of a photographic light source under which the scene-referred image data are acquired by employing a number of small image areas plotted within one of the light-source area frames, or a membership function in which a photographic EV value is a variable.

(15) The apparatus of item 11, wherein the white-balance adjusting section is further provided with a color-temperature estimating function for estimating a color temperature of a photographic light source for a respective one of the plurality of small image areas by employing a least squares method.

(16) The apparatus of item 15, wherein the white-balance adjusting section is further provided with a histogram creating function for creating a histogram based on an emerging frequency of the color temperature of the photographic light source for a respective one of the plurality of small image areas.

(17) The apparatus of item 16, wherein the white-balance adjusting section is further provided with a group-wise white-balance adjusting function for dividing the whole image area of the scene-referred image data into plural groups, based on the histogram created by the histogram creating function, so as to apply a different white-balance adjustment to a respective one of the plural groups, the different white-balance adjustment is one of various white-balance adjustments being different relative to each other corresponding to a respective one of the plural groups.

(18) The apparatus of item 10, wherein the applying amount determining section can arbitrarily establish a relationship between the white-balance data, indicating the degree of the white-balance adjustment, and an applying amount of the white-balance adjustment to be applied in practice.

(19) An apparatus for outputting a reproduced image onto an outputting medium, comprising: a receiving section to receive scene-referred raw data, which directly represent an image captured by an image-capturing apparatus while depending on image-capturing characteristics of the image-capturing apparatus, and to receive reproduction-auxiliary data in respect to the scene-referred raw data, and to receive white-balance data indicating a degree of white-balance adjustment; a scene-referred image data generating section to generate scene-referred image data from the scene-referred raw data received by the receiving section, based on the reproduction-auxiliary data received by the receiving section, by applying an image-capturing characteristic compensation processing to the scene-referred raw data; an output-referred image data generating section to generate output-referred image data, based on which a reproduced image is formed on an outputting medium, by applying an image-processing for optimizing an image quality of the reproduced image to the scene-referred image data generated by the scene-referred image data generating section; and an image-forming section to form the reproduced image on the outputting medium, based on the output-referred image data; wherein contents of the image-processing for optimizing the image quality of the reproduced image are determined on the basis of the white-balance data indicating the degree of white-balance adjustment.

(20) The apparatus of item 19, wherein the scene-referred image data are generated in a standardized format from the scene-referred raw data.

(21) The apparatus of item 19, wherein the receiving section also receives image-capturing data, which represent image-capturing conditions established at a time of capturing the image.

(22) The apparatus of item 19, wherein the receiving section receives a photographing EV value established at a time of capturing the image.

(23) The apparatus of item 19, further comprising: an applying amount determining section to determine an applying amount of the white-balance adjustment to be applied to the scene-referred image data, based on the white-balance data indicating the degree of the white-balance adjustment; wherein the output-referred image data generating section includes: a white-balance adjusting section to apply the applying amount of the white-balance adjustment, determined by the applying amount determining section, to the scene-referred image data.

(24) The apparatus of item 23, wherein the white-balance adjusting section is provided with an image area dividing function for dividing a whole image area of the scene-referred image data into a plurality of small image areas.

(25) The apparatus of item 24, wherein the white-balance adjusting section is further provided with a ratio calculating function for calculating a R/G ratio and a B/G ratio for a respective one of the plurality of small image areas, divided by the image area dividing function; and wherein the R/G ratio represents a ratio between an integrated value of R (Red) signals and another integrated value of G (Green) signals within each of the plurality of small image areas, while the B/G ratio represents a ratio between an integrated value of B (Blue) signals and another integrated value of G (Green) signals within each of the plurality of small image areas.

(26) The apparatus of item 25, wherein the white-balance adjusting section is further provided with a light-source estimating function for estimating a kind of a photographic light source for a respective one of the plurality of small image areas, by plotting the R/G ratio and the BIG ratio, calculated by the ratio calculating function, onto a light-source estimating map in which light-source area frames, indicating ranges of various combinations of the R/G ratio and the B/G ratio corresponding to various kinds of light-sources.

(27) The apparatus of item 26, wherein the white-balance adjusting section is further provided with a light-source determining function for determining a kind of a photographic light source under which the scene-referred image data are acquired by employing a number of small image areas plotted within one of the light-source area frames, or a membership function in which a photographic EV value is a variable.

(28) The apparatus of item 24, wherein the white-balance adjusting section is further provided with a color-temperature estimating function for estimating a color temperature of a photographic light source for a respective one of the plurality of small image areas by employing a least squares method.

(29) The apparatus of item 28, wherein the white-balance adjusting section is further provided with a histogram creating function for creating a histogram based on an emerging frequency of the color temperature of the photographic light source for a respective one of the plurality of small image areas.

(30) The apparatus of item 29, wherein the white-balance adjusting section is further provided with a group-wise white-balance adjusting function for dividing the whole image area of the scene-referred image data into plural groups, based on the histogram created by the histogram creating function, so as to apply a different white-balance adjustment to a respective one of the plural groups, the different white-balance adjustment is one of various white-balance adjustments being different relative to each other corresponding to a respective one of the plural groups.

(31) The apparatus of item 23, wherein the applying amount determining section can arbitrarily establish a relationship between the white-balance data, indicating the degree of the white-balance adjustment, and an applying amount of the white-balance adjustment to be applied in practice.

(32) A method for processing data, comprising the steps of: applying an image-capturing characteristic compensation processing to scene-referred raw data, which directly represent an image captured by an image-capturing apparatus while depending on image-capturing characteristics of the image-capturing apparatus, based on reproduction-auxiliary data in respect to the scene-referred raw data, in order to generate scene-referred image data from the scene-referred raw data; and generating output-referred image data, based on which a reproduced image is formed on an outputting medium, by applying an image-processing for optimizing an image quality of the reproduced image to the scene-referred image data generated in the applying step; wherein contents of the image-processing for optimizing the image quality of the reproduced image are determined on the basis of white-balance data indicating a degree of white-balance adjustment.

(33) The method of item 32, wherein the scene-referred image data are generated in a standardized format from the scene-referred raw data.

(34) The method of item 32, wherein the contents of the image-processing for optimizing the image quality of the reproduced image are determined on the basis of the white-balance data indicating the degree of white-balance adjustment and image-capturing data representing image-capturing conditions established at a time of capturing the image.

(35) The method of item 32, further comprising the steps of: determining an applying amount of the white-balance adjustment to be applied to the scene-referred image data, based on the white-balance data indicating the degree of the white-balance adjustment; and applying the applying amount of the white-balance adjustment, determined in the determining step, to the scene-referred image data.

(36) The method of item 35, further comprising the step of: dividing a whole image area of the scene-referred image data into a plurality of small image areas.

(37) The method of item 36, further comprising the step of: calculating a R/G ratio and a B/G ratio for a respective one of the plurality of small image areas, divided in the dividing step; wherein the R/G ratio represents a ratio between an integrated value of R (Red) signals and another integrated value of G (Green) signals within each of the plurality of small image areas, while the B/G ratio represents a ratio between an integrated value of B (Blue) signals and another integrated value of G (Green) signals within each of the plurality of small image areas.

(38) The method of item 37, further comprising the step of: estimating a kind of a photographic light source for a respective one of the plurality of small image areas, by plotting the R/G ratio and the B/G ratio, calculated in the calculating step, onto a light-source estimating map in which light-source area frames, indicating ranges of various combinations of the R/G ratio and the B/G ratio corresponding to various kinds of light-sources.

(39) The method of item 38, further comprising the step of: determining a kind of a photographic light source under which the scene-referred image data are acquired by employing a number of small image areas plotted within one of the light-source area frames, or a membership function in which a photographic EV value is a variable.

(40) The method of item 36, further comprising the step of: estimating a color temperature of a photographic light source for a respective one of the plurality of small image areas by employing a least squares method.

(41) The method of item 40, further comprising the step of: creating a histogram based on an emerging frequency of the color temperature of the photographic light source for a respective one of the plurality of small image areas.

(42) The method of item 41, further comprising the step of: dividing the whole image area of the scene-referred image data into plural groups, based on the histogram created in the creating step, so as to apply a different white-balance adjustment to a respective one of the plural groups, the different white-balance adjustment is one of various white-balance adjustments being different relative to each other corresponding to a respective one of the plural groups.

(43) The method of item 35, wherein a relationship between the white-balance data indicating the degree of the white-balance adjustment and an applying amount of the white-balance adjustment to be applied in practice can be arbitrarily established in the determining step for determining the applying amount of the white-balance adjustment.

(44) The method of item 32, further comprising the step of: receiving a photographing EV value established at a time of capturing the image.

(45) A computer program for executing data processing operations, comprising the functional steps of: applying an image-capturing characteristic compensation processing to scene-referred raw data, which directly represent an image captured by an image-capturing apparatus while depending on image-capturing characteristics of the image-capturing apparatus, based on reproduction-auxiliary data in respect to the scene-referred raw data, in order to generate scene-referred image data from the scene-referred raw data; and generating output-referred image data, based on which a reproduced image is formed on an outputting medium, by applying an image-processing for optimizing an image quality of the reproduced image to the scene-referred image data generated in the applying step; wherein contents of the image-processing for optimizing the image quality of the reproduced image are determined on the basis of white-balance data indicating a degree of white-balance adjustment.

(46) A recording medium that stores a computer program for executing data processing operations, wherein the computer program comprises the functional steps of: applying an image-capturing characteristic compensation processing to scene-referred raw data, which directly represent an image captured by an image-capturing apparatus while depending on image-capturing characteristics of the image-capturing apparatus, based on reproduction-auxiliary data in respect to the scene-referred raw data, in order to generate scene-referred image data from the scene-referred raw data; and generating output-referred image data, based on which a reproduced image is formed on an outputting medium, by applying an image-processing for optimizing an image quality of the reproduced image to the scene-referred image data generated in the applying step; and wherein contents of the image-processing for optimizing the image quality of the reproduced image are determined on the basis of white-balance data indicating a degree of white-balance adjustment.

Further, to overcome the abovementioned problems, other image-capturing apparatus, image-processing apparatus, image-processing processing methods and image-recording apparatus, embodied in the present invention, will be described as follow:

(47) An image-capturing apparatus, characterized in that

the image-capturing apparatus is provided with:

a scene-referred raw data generating means for generating scene-referred raw data dependent on the image-capturing characteristics of the image-capturing apparatus by an image capturing operation;

a reproduction-auxiliary data generating means for generating reproduction-auxiliary data based on which image-capturing characteristic compensation processing is to be applied to the above-mentioned scene-referred image data generated by the above-mentioned scene-referred raw data generating means, so as to generate scene-referred raw data standardized in respect to the scene-referred raw data;

a designating means for designating a degree of white-balance adjustment; and

a storage controlling means for attaching the reproduction-auxiliary data generated by the reproduction-auxiliary data generating means and data representing the degree of the white-balance adjustment designated by the designating means to the scene-referred raw data generated by the scene-referred raw data generating means, and further for storing them into a storage medium.

The term “generate” appearing in the description of the present Specification refers to the act of a new image signal or data being produced by a program and processing circuit working in the image-capturing apparatus, image processing apparatus and image recording apparatus according to the present invention. The term “create” may be used synonymously with it.

The “image-capturing apparatus” denotes an apparatus equipped with an image-capturing element (image sensor), and includes a so-called digital camera and scanner. The above-mentioned image-capturing element is exemplified by a CCD type image-capturing element with color sensitivity added through a combination of a Charge Coupled Device (CCD), a charge transfer device and a colored mosaic filter, and a CMOS type image-capturing device. The output current from those image-capturing devices is digitized by an analog-to-digital converter. The contents in each color channel in this phase represent signal intensities based on the spectral sensitivity inherent to the image-capturing device.

The above-mentioned “scene-referred raw data dependent on the image-capturing characteristics” denotes a raw signal directly outputted from the image-capturing apparatus with information on a subject being faithfully recorded. It refers to the data digitized by the analog-to-digital converter and the same data having been subjected to correction of such a noise as fixed pattern noise and dark current noise. It includes the above-mentioned RAW data. This scene-referred raw data is characterized by omission of the image processing for modifying the contents of data to improve such effects in image viewing as gradation conversion, sharpness enhancement and color saturation enhancement, and processing of mapping the signal intensify of each color channel based on the spectral sensitivity inherent to the image-capturing device, onto the standardized color space such as the above-mentioned RIMM and sRGB. The amount of information on the scene-referred raw data (e.g. number of gradations) is preferred to be equal to greater than that of the information required by the output-referred data (e.g. number of gradations), in conformity to the performances of the above-mentioned analog-to-digital converter. For example, when the number of gradations for the output-referred data is 8 bits per channel, the number of gradations for the scene-referred raw data is preferred to be 12 bits or more. It is more preferred to be 14 bits or more, and still more preferred to be 16 bits or more.

“Standardized scene-referred image data” signifies the image data characterized in that at least the signal intensity of each color channel based on the spectral sensitivity of the image-capturing device has been already mapped onto the above-mentioned standard color space such as RIMM RGB and ERIMM RGB, wherein this image data is further characterized by omission of image processing for modifying the data contents in order to improve such effects in viewing the image as gradation conversion, sharpness enhancement and color saturation enhancement. It is preferred that the scene-referred raw data be subjected to correction (opto-electronic conversion function defined in ISO1452, e.g. “Fine imaging and digital photographing” edited by the Publishing Commission of the Japan Society of Electrophotography, Corona Publishing Co., P. 479 of the photoelectric conversion characteristics of the image-capturing apparatus. The amount of the standardized scene-referred image data (e.g. number of gradations) is preferred to be equal to or greater than that of the information (e.g. number of gradations) required by the output-referred image data, in conformity to the above-mentioned analog-to-digital converter performances. For example, when the number of gradations for the output-referred image data is 8 bits per channel, then the number of gradations for the scene-referred image data is preferred to be equal to or greater than 12 bits. It is more preferred to be equal to or greater than 14 bits, and is still more preferred to be equal to or greater than 16 bits.

“Image-capturing characteristic compensation processing (also referred to as image-capturing device characteristic compensation processing) for generating the standardized scene-referred image data” is defined as the process of converting the above-mentioned “scene-referred raw data dependent on the image-capturing characteristics (also referred to as image-capturing device characteristic) of an image-capturing apparatus” into the “standardized scene-referred image data”. This processing depends on the state of “scene-referred raw data dependent on the image-capturing characteristics of the image-capturing apparatus”, and includes the step of mapping at least the signal intensity of each color channel based on the spectral sensitivity of the image-capturing device, onto the above-mentioned standard color space such as RIMM RGB and ERIMM RGB. For example, when the “scene-referred raw data dependent on the image-capturing characteristics of an image-capturing apparatus” is not subjected to interpolation processing based of the color filter arrangement, execution of this processing is essential. (For the details of the interpolation processing based of the color filter arrangement, see “Fine imaging and digital photographing” edited by the Publishing Commission of the Japan Society of Electrophotography, Corona Publishing Co., P. 51). This will provide “standardized scene-referred raw data” where the differences of signal values among different image-capturing apparatuses are corrected, while almost the same amount of information as that of “scene-referred raw data” is retained.

The “reproduction-auxiliary data based on which image-capturing characteristic compensation processing is applied” denotes the data based on which image-capturing characteristic compensation processing defined in the previous item can be applied, using only the information described in the data. This requires description of the information that permits mapping at least the signal intensity of each color channel based on the spectral sensitivity of the image-capturing device, onto the above-mentioned standard color space such as RIMM RGB and ERIMM RGB. To put it another way, this requires description of the matrix coefficient to be used for conversion into the specific standard color space such as RIMM RGB. For example, when only the device type of the image-capturing apparatus is described, it is possible that the image processing apparatus and image recording apparatus for executing this processing do not have a table showing correspondence between the device type name and the above-mentioned matrix coefficient. This cannot be said to be sufficient data. Further, even if there is no direct description of sufficient information for the execution of this processing, for example, the data can be said to be sufficient data if it contains description of the URL indicating the position of this information on the Internet. The “reproduction-auxiliary data based on which image-capturing characteristic compensation processing is applied” is preferred to be recorded as tag information to be written on the header of an image file.

If the above-mentioned “reproduction-auxiliary data based on which image-capturing characteristic compensation processing is applied” is stored in the medium, independently of the “scene-referred raw data”, information for associating the “reproduction-auxiliary data based on which image-capturing characteristic compensation processing is applied” with “scene-referred raw data” must be attached to both or either of them. Alternatively, a separate status information file containing the information on their relation must be attached to both or either of the two.

The “designating means for designating a degree of white-balance adjustment” (also referred to as designating section) denotes a structure that inputs a degree of white-balance adjustment to be applied to digital image data acquired by image-capturing operation continuously or in stepwise, corresponding to tastes of the photographer, from an operating switch or a liquid-crystal display having a touch panel equipped in the image-capturing apparatus. The structure of the “designating means for designating a degree of white-balance adjustment” can be anyone of various structures, such as an inputting unit coupled through an electric wire in a wired mode, an independent or a remote inputting unit coupled through a communication line or Internet, etc.

The term of “degree of white-balance adjustment” means at least a selected candidate in a range from the “non-compensation”, at which the color of the photographed light source is outputted as it is without applying the white-balance adjustment to the image signals acquired through an image-capturing element, to the “maximum compensation”, at which the white-balance adjustment is fully applied to the image signals at maximum. When the photographer wishes to remain the feeling of the photographed light source, he would select the “non-compensation”, while conversely, when the photographer wishes to completely compensate for the photographed light source, he would select the “maximum compensation”.

Further, the term of “designating” means that the photographer manually sets inputting data, by means of the operating switch or the liquid-crystal display having a touch panel equipped in the image-capturing apparatus as mentioned above.

Although it is applicable that the “data indicating said degree of said white-balance adjustment” (also referred to as white-balance data) are stored into the recording medium independently form the “scene-referred raw data”, it is specifically desirable that the white-balance data are stored in the image file as a form of tag information written into the header area.

In case that the “data indicating the degree of the white-balance adjustment” are stored into the recording medium independently form the “scene-referred raw data”, for at least one of the white-balance data and the “scene-referred raw data”, information correlating them with each other should be attached, or a status file including related information should be attached.

The “medium” is defined as a storage medium used to store “scene-referred raw data”, “reproduction-auxiliary data based on which image-capturing characteristic compensation processing is applied”, etc. It can be any one of the compact flash (registered trademark), memory stick, smart media, multi-media card, hard disk, floppy (registered trademark) disk, magnetic storage medium (MO) and CD-R. The unit for writing on the storage medium can be integral with the image-capturing apparatus, a wired write unit connected via a cord, or a wireless unit installed independently or at a remote site connected through a communications line or via the Internet. It is also possible to provide such a function that, when the image-capturing apparatus is connected with the write unit for writing on the storage medium, “reproduction-auxiliary data based on which image-capturing characteristic compensation processing is applied” and “required data” are read directly from the image processing apparatus or image recording apparatus. When “stored into a storage medium”, it is preferred that the standardized general-purpose file format such as TIFF, JPEG and Exif—not the format inherent to the image-capturing apparatus—be used.

(48) An image-processing apparatus, characterized in that

the image-processing apparatus is provided with:

an input means for inputting scene-referred raw data dependent on image-capturing characteristics of an image-capturing apparatus, reproduction-auxiliary data based on which image-capturing characteristic compensation processing is applied to the scene-referred raw data so as to generate the scene-referred image data standardized in respect to the scene-referred raw data, and data indicating a degree of white-balance adjustment;

a scene-referred image data generating means for generating the standardized scene-referred image data by applying image-capturing characteristic compensation processing to the scene-referred raw data inputted by the input means, based on the reproduction-auxiliary data for application of image-capturing characteristic compensation processing; and

an output data generating means for generating output data by attaching the data indicating the degree of the white-balance adjustment to the generated scene-referred image data.

The “input” described in item 48 indicates the process in which the “scene-referred raw data”, the “reproduction-auxiliary data based on which image-capturing characteristic compensation processing is applied” and the “data indicating the degree of the white-balance adjustment” are transmitted from an image-capturing apparatus to the image processing apparatus of the present invention.

For example, when a image-capturing apparatus is connected with the above-mentioned unit for writing into the storage medium, and the image processing apparatus has also a function of reading the “scene-referred raw data”, the “reproduction-auxiliary data based on which image-capturing characteristic compensation processing is applied” and the “data indicating the degree of the white-balance adjustment” directly from the image-capturing apparatus, then the image processing apparatus of the present invention has means for, connection with the image-capturing apparatus, and this connection means corresponds to the input section of the present invention. Further, when a portable “medium” such as a compact flash (registered trademark), memory stick, smart media, multi-media card, floppy (registered trademark) disk, photomagnetic storage medium (MO) or CD-R is used, then the image processing apparatus of the present invention has corresponding reading means, and this reading means corresponds to the input section of the present invention. Further, when the write unit is installed in a wireless state independently or at a remote site connected through a communications line or via the Internet, then the image processing apparatus of the present invention has communication means for connection with a communications line or the Internet, and this communications means corresponds to the input section of the present invention.

Further, in the embodiment of the present invention, it is applicable to employ the “data indicating the degree of the white-balance adjustment”, which are directly inputted from the software screen of the image-processing apparatus by the operator of the image-processing apparatus (sometimes, being different from the photographer concerned), without employing other “data indicating the degree of the white-balance adjustment”, which are designated by the photographer concerned and are inputted through the medium. In this case, it is applicable that only the “data indicating the degree of the white-balance adjustment” inputted from the image-processing apparatus by the operator are attached to the “scene-referred image data”, or both the “data indicating the degree of the white-balance adjustment” inputted from the image-processing apparatus and the other “data indicating the degree of the white-balance adjustment” designated by the photographer concerned are attached to the “scene-referred image data”.

(49) An image-capturing apparatus, characterized in that

the image-capturing apparatus is provided with:

a scene-referred raw data generating means for generating scene-referred raw data dependent on the image-capturing characteristics of the image-capturing apparatus by an image capturing operation;

a reproduction-auxiliary data generating means for generating reproduction-auxiliary data based on which image-capturing characteristic compensation processing is to be applied to the above-mentioned scene-referred image data generated by the above-mentioned scene-referred raw data generating means, so as to generate scene-referred raw data standardized in respect to the scene-referred raw data;

an image-capturing information data generating means for generating image-capturing information data being an image-capturing condition setting at a time of an image-capturing operation;

a designating means for designating a degree of white-balance adjustment; and

a storage controlling means for attaching the reproduction-auxiliary data generated by the reproduction-auxiliary data generating means, the image-capturing information data generated by the image-capturing information data generating means and data representing the degree of the white-balance adjustment designated by the designating means to the scene-referred raw data generated by the scene-referred raw data generating means, and further for storing them into a storage medium.

The “output-referred image data” (also referred to as “visual image referred image data”) denotes digital image data that is used by such a display device as CRT, liquid crystal display and plasma display, or by the output device for generation of a hard copy image on such an outputting medium as silver halide photographic paper, inkjet paper and thermal printing paper. The output-referred image data is provided with “optimization processing” in order to obtain the optimum image on such a display device as CRT, liquid crystal display and plasma display, or such an outputting medium as silver halide photographic paper, inkjet paper and thermal printing paper.

The “image-capturing data” (also referred to as “image-capturing information data”) described in the present invention is a record representing photographing conditions at a time of photographing. It may contain the same as the tag information written into the header of the Exif file. To put it more specifically, it denotes the tag (code) representing the exposure time, shutter speed, f-stop number (F number), ISO sensitivity, brightness value, subject distance range, light source, on/off status of a stroboscopic lamp, subject area, white balance, zoom scaling factor, subject configuration, photographing scene type, the amount of reflected light of the stroboscopic lamp source and color saturation for photographing.

The above-mentioned “image-capturing data” can be divided into (1) the value captured at a time of photographing by a sensor mounted on the camera for automating the exposure setting and focusing functions of the image-capturing apparatus, (2) the data obtained by processing the value captured by the sensor, and (3) photographing conditions of the camera set on the basis of the value captured by the sensor. In addition to these, it also includes the information manually set by a user on the photographing mode dial (e.g. portrait, sports and macro photographing mode) and the setting switch for forced lighting of a stroboscopic lamp.

The “image-capturing data” can be arranged to be stored on the medium independently of “scene-referred raw data”. It is particularly preferred to be recorded in the image file in the form of tag information that can be written on the header.

When the “image-capturing data” is configured to be stored in the medium independently of the “scene-referred raw data”, information for associating “image-capturing data” with “scene-referred raw data” must be attached to both or either of them. Alternatively, a separate status information file containing the information on their relation must be attached to both or either of the two.

(50) An image-processing apparatus, characterized in that

the image-processing apparatus is provided with:

an input means for inputting scene-referred raw data dependent on image-capturing characteristics of an image-capturing apparatus, reproduction-auxiliary data based on which image-capturing characteristic compensation processing is applied to the scene-referred raw data so as to generate the scene-referred image data standardized in respect to the scene-referred raw data, image-capturing information data being an image-capturing condition setting at a time of an image-capturing operation and data indicating a degree of white-balance adjustment;

a scene-referred image data generating means for generating the standardized scene-referred image data by applying image-capturing characteristic compensation processing to the scene-referred raw data inputted by the input means, based on the reproduction-auxiliary data for application of image-capturing characteristic compensation processing; and

an output data generating means for generating output data by attaching the image-capturing information data being the image-capturing condition setting at the time of the image-capturing operation and the data indicating the degree of the white-balance adjustment to the generated scene-referred image data.

(51) The image-processing apparatus, described in item 48 characterized in that

the image-processing apparatus is further provided with:

an output-referred image data generating means for generating output-referred image data, by applying an image-processing, contents of which are determined on the basis of the data indicating the degree of the white-balance adjustment and which optimizes an image quality of a visual image formed on an outputting medium, to the standardized scene-referred image data.

The “outputting medium” appearing in the present invention is defined as including such a display device as CRT, liquid crystal display and plasma display, or such paper for generation of a hard copy image as silver halide photographic paper, inkjet paper and thermal printing paper.

The “image-processing, which optimizes an image quality of a visual image formed on an outputting medium” is provided to ensure the optimum image on such display device as CRT, liquid crystal display and plasma display, or such an outputting medium as silver halide photographic paper, inkjet paper and thermal printing paper. For example, when display is given on the CRT display monitor conforming to the sRGB standard, processing is provided in such a way that the optimum color reproduction can be gained within the color gamut of the sRGB standard. When the data is to be outputted on silver halide photographic paper, processing is provided in such a way that the optimum color reproduction can be gained within the color gamut of silver halide photographic paper. In addition to compression of the above-mentioned color gamut, compression of gradation from 16 to 8 bits, reduction in the number of output pixels, and processing in response to the output characteristics (LUT) of the output device are also included. Further, it goes without saying that such processing as noise control, sharpening, white balance adjustment, color saturation adjustment or dodging is carried out.

Further, in the image-processing apparatus embodied in the present invention, it is applicable to employ the “data indicating the degree of the white-balance adjustment”, which are directly inputted from the image-processing apparatus by the operator of the image-processing apparatus, without employing other “data indicating the degree of the white-balance adjustment”, which are designated by the photographer concerned and are inputted through the medium. In addition, it is desirable that the “data indicating the degree of the white-balance adjustment” are attached to the “scene-referred image data” generated by the image-processing apparatus embodied in the present invention.

The “data indicating the degree of the white-balance adjustment” can be arranged to be stored on the medium independently of the “scene-referred raw data”, the “scene-referred image data” and the “output-referred image data”. It is particularly preferred to be recorded in the image file in the form of tag information that can be written on the header.

In case that the “data indicating the degree of the white-balance adjustment” are stored into the recording medium independently form the “scene-referred raw data”, the “scene-referred image data” and the “output-referred image data”, information correlating the “data indicating the degree of the white-balance adjustment” with one of the “scene-referred raw data”, the “scene-referred image data” and the “output-referred image data” should be attached to one of them or both of them, or a status file including related information should be attached.

It is applicable that only the “data indicating the degree of the white-balance adjustment” inputted from the image-processing apparatus by the operator are attached to the “scene-referred image data”, the “scene-referred image data” and the “output-referred image data”, or both the “data indicating the degree of the white-balance adjustment” designated by the photographer and inputted from the image-processing apparatus and the other “data indicating the degree of the white-balance adjustment” designated by the photographer concerned are attached to the “scene-referred image data”, the “scene-referred image data” and the “output-referred image data”.

(52) The image-processing apparatus, described in item 50 characterized in that

the image-processing apparatus is further provided with:

an output-referred image data generating means for generating output-referred image data, by applying an image-processing, contents of which are determined on the basis of the image-capturing information data and the data indicating the degree of the white-balance adjustment and which optimizes an image quality of a visual image formed on an outputting medium, to the standardized scene-referred image data.

The following shows an example of optimizing the output-referred image data using the “image-capturing data”:

“Subject configuration” information allows color saturation enhancement processing to be partially carried out, and permits dodging to be carried out for the scene containing an extensive dynamic range.

“Photographing scene type” allows special adjustment of color balance to be made by reducing the degree of white balance adjustment is loosened, in photographing of a night view, for example.

The distance between the photographer and subject can be estimated from the information in the “amount of reflected light from a stroboscopic light source”. The result can be effectively utilized in setting the conditions for image processing in order to reduce the white skipping of the skin of the subject, for example.

The information on “subject type” allows the degree of sharpness to be reduced and processing of smoothening to be enhanced in a people photograph, for example, thereby making the wrinkles on the skin less conspicuous.

In order to compensate for information on “image-capturing data”, “subject configuration”, “photographing scene type”, “amount of reflected light from a stroboscopic light source” and “subject type”, it is possible to use information on “exposure time”, “shutter speed”, “f-stop number (F number)”, “ISO sensitivity”, “brightness value”, “subject distance range”, “light source”, “on/off status of a stroboscopic lamp”, “subject area”, “white balance”, “zoom scaling factor”, etc. for supplementary purpose. Further, the amount of noise control processing can be adjusted based on the “ISO sensitivity” information, and the “light source” information can be used for readjustment of white balance.

(53) An image-recording apparatus, characterized in that

the image-recording apparatus is provided with:

an input means for inputting scene-referred raw data dependent on image-capturing characteristics of an image-capturing apparatus, reproduction-auxiliary data based on which image-capturing characteristic compensation processing is applied to the scene-referred raw data so as to generate the scene-referred image data standardized in respect to the scene-referred raw data, and data indicating a degree of white-balance adjustment;

a scene-referred image data generating means for generating the standardized scene-referred image data by applying image-capturing characteristic compensation processing to the scene-referred raw data inputted by the input means, based on the reproduction-auxiliary data for application of image-capturing characteristic compensation processing;

an output-referred image data generating means for generating output-referred image data, by applying an image-processing, contents of which are determined on the basis of the data indicating the degree of the white-balance adjustment and which optimizes an image quality of a visual image formed on an outputting medium, to the standardized scene-referred image data generated by the scene-referred image data generating means; and

an image-forming means for forming a visual image on a outputting medium by using the output-referred image data generated by the output-referred image data generating means.

(54) An image-recording apparatus, characterized in that

the image-recording apparatus is provided with:

an input means for inputting scene-referred raw data dependent on image-capturing characteristics of an image-capturing apparatus, reproduction-auxiliary data based on which image-capturing characteristic compensation processing is applied to the scene-referred raw data so as to generate the scene-referred image data standardized in respect to the scene-referred raw data, data indicating a degree of white-balance adjustment and image-capturing information data being an image-capturing condition setting at a time of an image-capturing operation;

a scene-referred image data generating means for generating the standardized scene-referred image data by applying image-capturing characteristic compensation processing to the scene-referred raw data inputted by the input means, based on the reproduction-auxiliary data for application of image-capturing characteristic compensation processing;

an output-referred image data generating means for generating output-referred image data, by applying an image-processing, contents of which are determined on the basis of the data indicating the degree of the white-balance adjustment and the image-capturing information data being the image-capturing condition setting at the time of the image-capturing operation, and which optimizes an image quality of a visual image formed on an outputting medium, to the standardized scene-referred image data generated by the scene-referred image data generating means; and

an image-forming means for forming a visual image on a outputting medium by using the output-referred image data generated by the output-referred image data generating means.

The image recording apparatus of the present invention can be equipped with a film scanner for inputting the frame image information of the photosensitive material recorded by an analog camera including a color film, color reversal film, black-and-white negative and black-and-white reversal film, or a flat head scanner for inputting the image information reproduced on color paper as silver halide photographic paper, in addition to the mechanism of applying image processing of the present invention to the digital image data obtained by the image-capturing apparatus of the present invention. It can be equipped with means for reading digital image data obtained by a digital camera other than the image-capturing apparatus of the present invention and stored in the known portable “medium” including a compact flash (registered trademark), memory stick, smart media, multimedia card, floppy (registered trademark) disk, photomagnetic storage medium (MO) or CD-R. Alternatively, it can be equipped with processing means for forming an output-referred image on a display device such as a CRT, liquid crystal display and plasma display, and a storage medium of any known type including silver halide photographic paper, inkjet paper and thermal printing paper, by obtaining digital image data from a remote place through communications means such as the Internet.

(55) The image-capturing apparatus, described in item 47 or item 49, characterized in that

the storage controlling means attaches a photographing EV value at a time of capturing the image to the scene-referred image data and stores them into the medium.

In the present invention, as described in item 55, it is desirable that the image-capturing apparatus itself calculates the “photographing EV value” at the time when the release switch of the image-capturing apparatus is depressed up to its half-stroke, and stores it with the “data indicating the degree of the white-balance adjustment” into the medium.

The “photographing EV value” can be arranged to be stored on the medium independently of the “scene-referred raw data” as well as the “data indicating the degree of the white-balance adjustment” and the “image-capturing information data”. It is particularly preferred to be recorded in the image file in the form of tag information that can be written on the header of the “scene-referred raw data”.

In case that the “photographing EV value” is stored into the recording medium independently of the “scene-referred raw data”, for at least one of the “photographing EV value” and the “scene-referred raw data”, information correlating them with each other should be attached, or a status file including related information should be attached.

(56) The image-processing apparatus, described in anyone of items 47, 50, 51 and 52, characterized in that

the input means input a photographing EV value at a time of capturing the image.

In the image-processing apparatus embodied in the present invention, it is applicable that the “photographing EV value” can be inputted from the image-capturing apparatus through the medium, or the “photographing EV value” can be inputted from the image-processing apparatus by the operator. Further, it is desirable that the “photographing EV value” is attached to the “scene-referred image data” and the “output-referred image data” generated by the image-processing apparatus embodied in the present invention. It is also possible to attach the “photographing EV value” to the “scene-referred raw data”. At this time, it is particularly preferred for the “photographing EV value” to be recorded in the image file in the form of tag information that can be written on each of the headers of the “scene-referred raw data”, the “scene-referred image data” and the “output-referred image data”.

In case that the “photographing EV value” is stored into the recording medium independently of the “scene-referred raw data”, the “scene-referred image data” and the “output-referred image data”, information correlating the “photographing EV value” with one of the “scene-referred raw data”, the “scene-referred image data” and the “output-referred image data” should be attached to one of them or both of them, or a status file including related information should be attached.

(57) The image-processing apparatus, described in anyone of items 51, 52 and 56, characterized in that

the image-processing apparatus is further provided with:

an applying amount determining means for determining an applying amount of the white-balance adjustment to be applied to the scene-referred image data, based on the data indicating the degree of the white-balance adjustment; and

the output-referred image data generating means has a white-balance adjusting means for applying the applying amount of the white-balance adjustment, determined in the above, to the scene-referred image data.

(58) The image-processing apparatus, described in item 57, characterized in that

the white-balance adjusting section is provided with an image area dividing means for dividing a whole image area of the scene-referred image data into a plurality of small image areas.

(59) The image-processing apparatus, described in item 58, characterized in that

the white-balance adjusting section is provided with a R/G, B/G calculating means for finding a R/G ratio between an integrated value of R (Red) signals and another integrated value of G (Green) signals, and a B/G ratio between an integrated value of B (Blue) signals and another integrated value of G (Green) signals, for a respective one of the plurality of small image areas.

(60) The image-processing apparatus, described in item 59, characterized in that

the white-balance adjusting section is provided with a first light-source judging means for estimating a kind of a photographic light source for a respective one of the plurality of small image areas, by plotting the R/G and the B/G, calculated in the above, onto a light-source estimating map in which light-source area frames, indicating ranges of various combinations of the R/G and the B/G corresponding to various kinds of photographing light-sources.

(61) The image-processing apparatus, described in item 60, characterized in that

the white-balance adjusting section is provided with a second light-source judging means for judging a kind of a photographic light source, under which the scene-referred image data are acquired, by employing a number of small image areas plotted within one of the light-source area frames, or a membership function in which a photographic EV value is a variable.

(62) The image-processing apparatus, described in item 58, characterized in that

the white-balance adjusting section is provided with a color-temperature estimating means for estimating a color temperature of a photographic light source for a respective one of the plurality of small image areas by employing a least squares method.

(63) The image-processing apparatus, described in item 62, characterized in that

the white-balance adjusting section is provided with a histogram creating means for creating a histogram based on an emerging frequency of the color temperature of the photographic light source for a respective one of the plurality of small image areas.

(64) The image-processing apparatus, described in item 63, characterized in that

the white-balance adjusting section is provided with a group-wise white-balance adjusting means for dividing the whole image area of the scene-referred image data into equal to or more than two groups, based on the histogram created in the above, so as to apply a white-balance adjustment, being different for every group, to a respective one of the plural groups.

(65) The image-processing apparatus, described in anyone of items 57-64, characterized in that

the applying amount determining section can arbitrarily establish a relationship between the data indicating the degree of the white-balance adjustment, and an applying amount of the white-balance adjustment in practice.

(66) The image-recording apparatus, described in item 53 or item 54, characterized in that

the input means inputs a photographing EV value at a time of capturing the image.

In the image-recording apparatus embodied in the present invention, it is applicable that the “photographing EV value” is inputted for use from the image-capturing apparatus and the image-processing apparatus, or the “photographing EV value” is inputted by the operator from the image-recording apparatus.

(67) The image-recording apparatus, described in anyone of items 53, 54 and 66, characterized in that

the image-recording apparatus is further provided with:

an applying amount determining means for determining an applying amount of the white-balance adjustment to be applied to the scene-referred image data, based on the data indicating the degree of the white-balance adjustment; and

the output-referred image data generating means has a white-balance adjusting means for applying the applying amount of the white-balance adjustment, determined in the above, to the scene-referred image data.

(68) The image-recording apparatus, described in item 67, characterized in that

the white-balance adjusting section is provided with an image area dividing means for dividing a whole image area of the scene-referred image data into a plurality of small image areas.

(69) The image-recording apparatus, described in item 68, characterized in that

the white-balance adjusting section is provided with a R/G, B/G calculating means for finding a R/G ratio between an integrated value of R (Red) signals and another integrated value of G (Green) signals, and a B/G ratio between an integrated value of B (Blue) signals and another integrated value of G (Green) signals, for a respective one of the plurality of small image areas.

(70) The image-recording apparatus, described in item 69, characterized in that

the white-balance adjusting section is provided with a first light-source judging means for estimating a kind of a photographic light source for a respective one of the plurality of small image areas, by plotting the R/G and the B/G, calculated in the above, onto a light-source estimating map in which light-source area frames, indicating ranges of various combinations of the R/G and the B/G corresponding to various kinds of photographing light-sources.

(71) The image-recording apparatus, described in item 70, characterized in that

the white-balance adjusting section is provided with a second light-source judging means for judging a kind of a photographic light source, under which the scene-referred image data are acquired, by employing a number of small image areas plotted within one of the light-source area frames, or a membership function in which a photographic EV value is a variable.

(72) The image-recording apparatus, described in item 68, characterized in that

the white-balance adjusting section is provided with a color-temperature estimating means for estimating a color temperature of a photographic light source for a respective one of the plurality of small image areas by employing a least squares method.

(73) The image-recording apparatus, described in item 72, characterized in that

the white-balance adjusting section is provided with a histogram creating means for creating a histogram based on an emerging frequency of the color temperature of the photographic light source for a respective one of the plurality of small image areas.

(74) The image-recording apparatus, described in item 73, characterized in that

the white-balance adjusting section is provided with a group-wise white-balance adjusting means for dividing the whole image area of the scene-referred image data into equal to or more than two groups, based on the histogram created in the above, so as to apply a white-balance adjustment, being different for every group, to a respective one of the plural groups.

(75) The image-recording apparatus, described in anyone of items 67-74, characterized in that

the applying amount determining section can arbitrarily establish a relationship between the data indicating the degree of the white-balance adjustment, and an applying amount of the white-balance adjustment in practice.

(76) An image-processing method, characterized in that

the image-processing method includes:

a scene-referred image data generating process for generating the standardized scene-referred image data by applying an image-capturing characteristic compensation processing to the scene-referred raw data, based on reproduction-auxiliary data for application of the image-capturing characteristic compensation processing; and

an output-referred image data generating process for generating output-referred image data, by applying an image-processing, contents of which are determined on the basis of data indicating the degree of the white-balance adjustment and which optimizes an image quality of a visual image formed on an outputting medium, to the scene-referred image data.

(77) An image-processing method, characterized in that

the image-processing method includes:

a scene-referred image data generating process for generating the standardized scene-referred image data by applying an image-capturing characteristic compensation processing to the scene-referred raw data, based on reproduction-auxiliary data for application of the image-capturing characteristic compensation processing; and

an output-referred image data generating process for generating output-referred image data, by applying an image-processing, contents of which are determined on the basis of image-capturing information data and data indicating the degree of the white-balance adjustment and which optimizes an image quality of a visual image formed on an outputting medium, to the scene-referred image data.

(78) The image-processing method, described in item 76 or item 77, characterized in that

the image-processing method includes:

an applying amount determining process for determining an applying amount of the white-balance adjustment, based on the data indicating the degree of the white-balance adjustment; and

a white-balance adjusting process for applying the applying amount of the white-balance adjustment, determined in the above, to the scene-referred image data.

(79) The image-processing method, described in item 78, characterized in that

the white-balance adjusting process includes an image area dividing process for dividing a whole image area of the scene-referred image data into a plurality of small image areas.

(80) The image-processing method, described in item 79, characterized in that

the white-balance adjusting process includes a R/G, B/G calculating process for finding a R/G ratio between an integrated value of R (Red) signals and another integrated value of G (Green) signals, and a B/G ratio between an integrated value of B (Blue) signals and another integrated value of G (Green) signals, for a respective one of the plurality of small image areas.

(81) The image-processing method, described in item 80, characterized in that

the white-balance adjusting process includes a first light-source judging process for estimating a kind of a photographic light source for a respective one of the plurality of small image areas, by plotting the R/G and the B/G, calculated in the above, onto a light-source estimating map in which light-source area frames, indicating ranges of various combinations of the R/G and the B/G corresponding to various kinds of photographing light-sources.

(82) The image-processing method, described in item 81, characterized in that

the white-balance adjusting process includes a second light-source judging process for judging a kind of a photographic light source, under which the scene-referred image data are acquired, by employing a number of small image areas plotted within one of the light-source area frames, or a membership function in which a photographic EV value is a variable.

(83) The image-processing method, described in item 79, characterized in that

the white-balance adjusting process includes a color-temperature estimating process for estimating a color temperature of a photographic light source for a respective one of the plurality of small image areas by employing a least squares method.

(84) The image-processing method, described in item 83, characterized in that

the white-balance adjusting process includes a histogram creating process for creating a histogram based on an emerging frequency of the color temperature of the photographic light source for a respective one of the plurality of small image areas.

(85) The image-processing method, described in item 84, characterized in that

the white-balance adjusting process includes a group-wise white-balance adjusting process for dividing the whole image area of the scene-referred image data into equal to or more than two groups, based on the histogram created in the above, so as to apply a white-balance adjustment, being different for every group, to a respective one of the plural groups.

(86) The image-processing method, described in anyone of items 78-85, characterized in that

the applying amount determining process can arbitrarily establish a relationship between the data indicating the degree of the white-balance adjustment, and an applying amount of the white-balance adjustment in practice.

(87) The image-processing method, described in anyone of items 76-86, characterized in that

the white-balance adjusting process includes an inputting process for inputting a photographing EV value.

(88) A program for realizing the image-processing method, described in anyone of items 76-87, in a computer.

(89) A recording medium in which the program, described in item 88, is recorded.

As described in the foregoing, the image-capturing apparatus of the present invention makes it possible to output: scene-referred raw data d2 as an direct raw output signal of the image-capturing apparatus faithfully recording the information of a subject, wherein there is omission of image processing of intentionally modifying the contents of data to improve the effect in viewing the image such as conversion of gradation, and enhancement of sharpness and color saturation, and the processing of mapping signal enhancement of each color channel based on the spectral sensitivity inherent to the image-capturing device, into the above-mentioned standardized color space such as RIMM RGB and sRGB; the sufficient data for carrying out image-capturing characteristic compensation processing wherein the spectral sensitivity inherent to the image-capturing device or the matrix coefficient to be used for conversion into the standardized color space such as RIMM RGB and sRGB are written; and the data designating the degree of the white-balance adjustment, designated by the photographer. At the same time, the above-mentioned image-capturing apparatus 21 omits processing of conversion into the scene-referred image data in the image-capturing apparatus, thereby reducing the processing load and power consumption of the image-capturing apparatus, improving the processing (photographing) capability and increasing the number of sheets to be processed (shot) in the battery mode. Further, it becomes possible to conduct the white-balance adjustment reflecting the tastes of the photographer, by outputting the data designating the degree of the white-balance adjustment, designated by the photographer.

Further, according to the image-processing apparatus embodied in the present invention, it becomes possible to utilize the scene-referred raw data, outputted from the image-capturing apparatus, for a print outputting use in home or office environment. Still further, the image processing apparatus of the present invention allows the scene-referred image data to be generated from the scene-referred raw data outputted from the image-capturing apparatus, and creates the optimized output-referred image data, without the image-capturing information being lost, so that it is outputted to the onto such a display device as CRT, liquid crystal display and plasma display, and a storage medium of any known type such as paper for generation of hardcopy images including silver halide photographic paper, inkjet paper and thermal printing paper.

Still further, according to the image-capturing apparatus embodied in the present invention, by generating the scene-referred image data from the scene-referred raw data outputted from the image-capturing apparatus, it becomes possible to form an optimized image from the output-referred image data without losing information of the captured image onto an outputting medium, such as anyone of display devices including a CRT, a liquid crystal display, a plasma display, etc., or anyone of hard copy papers including a silver halide photographic paper, an inkjet paper, a thermal printing paper, etc.

Still further, the image-capturing apparatus, the image-processing apparatus, the image-recording apparatus and the image-processing method for the same, embodied in the present invention, make it possible to select an favorable color finishing of the image having a scene captured under various light sources, such as a sunset light, a tungsten light, a candle light, etc., from a color tone just same as viewer's sight, a color tone under the daylight, etc., corresponding to not only tastes of the photographer at the time of capturing the image, but also tastes of the photographer after the time of capturing the image, the person who creates its print and the viewer of the image, without generating the deterioration of the image quality, caused by the image compression processing.

Still further, the program for executing the image-processing method of the present invention and the recording medium storing the program make it possible to execute the technical features of the present invention in other hardware, such as, for instance, the conventional image-processing apparatus and the conventional image-recording apparatus.

### BRIEF DESCRIPTION OF THE DRAWINGS

Other objects and advantages of the present invention will become apparent upon reading the following detailed description and upon reference to the drawings in which:

FIG. 1 shows a block diagram representing the functional configuration of an image-capturing apparatus embodied in the present invention;

FIG. 2(a) and FIG. 2(b) show examples of white-balance applying rate inputting screens for inputting a degree of white-balance adjustment corresponding to the user's tastes;

FIG. 3 shows a flowchart representing the scene-referred raw data storage processing A1 to be carried out under control of the control section;

FIG. 4 shows a diagram representing a configuration of digital image data recorded on the recording medium of a memory device;

FIG. 5 shows a block diagram representing a functional configuration of the image-capturing apparatus embodied in the present invention;

FIG. 6 shows a flowchart representing a scene-referred raw data storage processing B1 to be carried out under control of the control section;

FIG. 7 shows a diagram representing a data configuration of digital image data recorded on a recording medium of the storage device;

FIG. 8 shows a block diagram representing the functional configuration of an image processing apparatus embodied in the present invention;

FIG. 9 shows a detailed configuration of an output-referred image data generating section;

FIG. 10 shows a flowchart representing image data generation processing to be carried out by interconnection among various parts of the image processing apparatus;

FIG. 11 shows a procedure flowchart of generating output-referred image data from scene-referred image data;

FIG. 12 shows a light-source estimating map in which light source area frames, each of which indicates a color distribution range for every kind of light source, are established;

FIG. 13 shows a membership function in which a tendency value (outdoor tendency value) is defined, as an example of the membership function in which the tendency value is defined with the photographic EV value as a variable;

FIG. 14 shows a membership function in which a tendency value (shade-cloudiness tendency value) is defined, as an example of the membership function in which the tendency value is defined with a number of small image areas for every kind of light source as a variable;

FIG. 15 shows locus of the white-balance adjustment based on a position of the light source estimated on the light source estimating map and applying rate data;

FIG. 16 shows an internal configuration of an output-referred image data generating section employing a white-balance adjusting method, which adjusts the white-balance by estimating a color temperature for every small image area;

FIG. 17 shows an example of optimization processing B1 including the white-balance adjustment;

FIG. 18 shows a chromaticity diagram for explaining a principle of the color temperature estimating method;

FIG. 19 shows a white-balance applying-rate inputting screen displayed on the display device;

FIG. 20 shows a diagram representing output data configuration for generating scene-referred image data and outputting it to the memory device;

FIG. 21 shows a diagram representing another output data configuration for generating scene-referred image data and outputting it to the memory device;

FIG. 22 shows an external perspective view representing an image recording apparatus embodied in the present invention;

FIG. 23 shows a diagram representing an internal configuration of the image recording apparatus embodied in the present invention;

FIG. 24 shows a block diagram representing the functional configuration of an image processing apparatus embodied in the present invention; and

FIG. 25 shows a flowchart representing image data formation processing to be carried out by interconnection among various parts of the image recording apparatus.

### DETAILED DESCRIPTION OF THE PREFERRED EMBODIMENT

Referring to the drawings, desirable embodiments of the image-capturing apparatus, embodied in the present invention, will be detailed in the following. Incidentally, “data indicating a degree of white-balance adjustment” is denoted as “applying rate data”, in the following descriptions.

### Configuration of Image-Capturing Apparatus

Initially, the configuration will be detailed in the following.

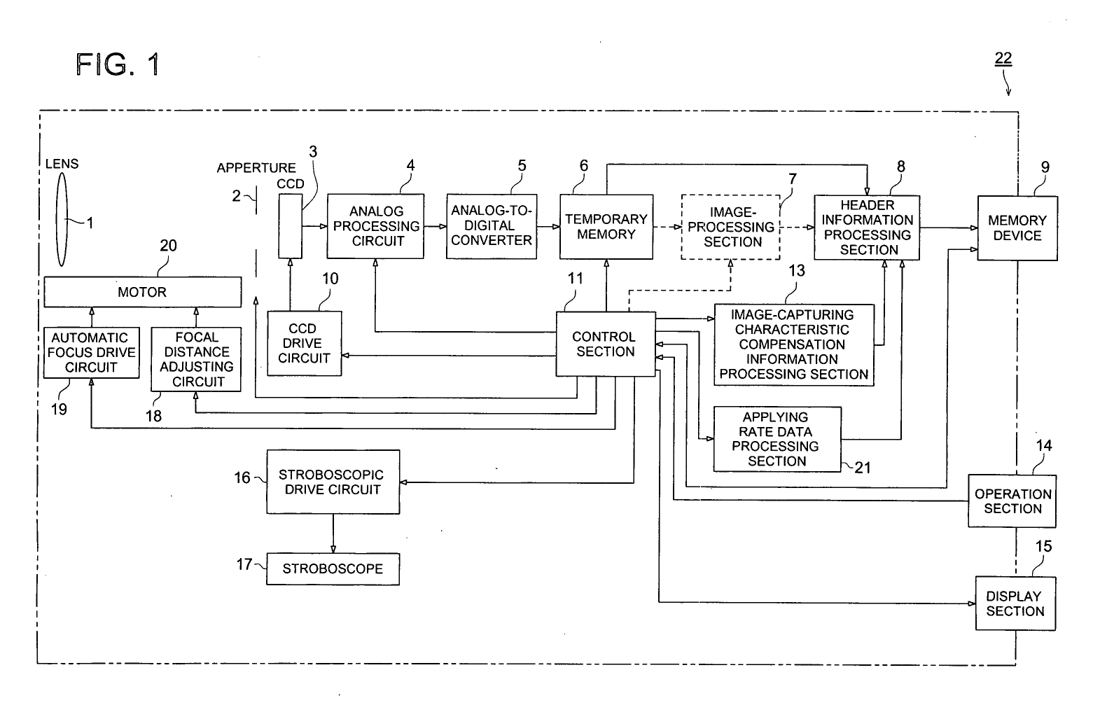

FIG. 1 is a block diagram representing the functional configuration of an image-capturing apparatus 22 of the present invention. As shown in FIG. 1, the image-capturing apparatus 22 includes a lens 1, aperture 2, CCD 3, analog processing circuit 4, analog-to-digital converter 5, temporary memory 6, image processing section 7, header information processing section 8, memory device 9, CCD drive circuit 10, control section 11, image-capturing characteristic compensation information processing section 13, operation section 14, display section 15, stroboscopic drive circuit 16, stroboscope 17, focal distance adjusting circuit 18, automatic focus drive circuit 19, motor 20, applying-rate data processing section 21, etc.

The optical system of the image-capturing apparatus 22 comprises a lens 1, aperture 2 and CCD (solid image-capturing device) 3.

The lens 1 adjusts the focus to form the optical image of a subject. The aperture 2 adjusts the amount of light of the ray bundle having passed through the lens 1. The CCD3 provides photoelectric conversion in such a way that the light of the subject whose image has been formed on the light receiving surface by means of the lens 1 is converted into electric signals (image-capturing signals) in the amount conforming to the amount of incoming light for each sensor. The CCD3 controls the timing pulse produced from the CCD drive circuit 10, whereby image-capturing signals are sequentially output to the analog processing circuit 4.

In response to image-capturing signals inputted from the CCD3, the analog processing circuit 4 carries out amplification processing for the R, G and B signals and noise reduction. Processing by this analog processing circuit 4 is turned on or off in response to the operation signal from the operation section 14.

The analog-to-digital converter 5 converts into the digital image data the image-capturing signal inputted from the analog processing circuit 4.

The temporary memory 6 serves as a buffer memory or the like, and temporarily stores the digital image data outputted from the analog-to-digital converter 5.

The image processing section 7 performs processing of image size change, trimming, aspect conversion in addition to processing of the digital image data gradation correction used for display in the display section 15, spectral sensitivity stroke correction, dark current noise control, sharpening, white balance adjustment and color saturation adjustment. Processing by the image processing section 7 is turned on or off in response to the operation signal from the operation section 14.

The header information processing section 8 process the digital image data stored in the temporary memory 6 in such a way that image-capturing characteristic compensation data d2 generated by the image-capturing characteristic compensation information processing section 13 is written as header information.

The memory device 9 is composed of nonvolatile semiconductor memory and others, and comprises such a recording media as memory card for recording the digital image data gained by photographing and a readable memory retaining the control program of the image-capturing apparatus 22, various kinds of processing programs, data for executing the programs, the applying rate data for the white-balance adjustment, various kinds of setting data including the recording mode of digital image data acquired by the image-capturing operation, etc.

The CCD drive circuit 10 issues timing pulses based on the control signal produced from the control section 11 and performs drive control of the CCD3.

The control section 11, including functions as the “scene-referred raw data generating means” and the “record controlling means”, is composed of the CPU (Central Processing Unit) and the RAM (Random Access Memory), etc., and reads the control program for the image-capturing apparatus 22 and the various kinds of processing programs, both stored in the memory device 9, to conduct controlling operations for the image-capturing apparatus 22 as a whole and various kinds of processing operations. Concretely speaking, when the record of the scene-referred raw data is established, the control section 11 executes scene-referred raw data storing operation A1 detailed later, in response to operations of the release switch from the operating section 14. In the scene-referred raw data storing operation A1, the control section 11 controls various sections in response to the first stage operation of the release switch (operation of pressing the release switch up to its half-stroke), and conducts photometry and ranging operations to calculate the AF (Auto Focus) evaluation value and the photographic EV value, and then, temporally stores the calculated photographic EV value into the RAM. Successively, the control section 11 conducts the image-capturing operation in response to the second stage operation of the release switch (operation of pressing the release switch up to its full-stroke), and generates scene-referred raw data d1 from the photographed image signals acquired by the image-capturing operation without conducting the signal amplifying operation in analogue processing section 4, the noise reduction processing and the image processing operation in image-processing section 7. Then, the image-capturing characteristic compensation data d2 and the applying rate data d3 are attached to scene-referred raw data d1 as the header information to store all of them into the recording medium of the memory device 9.

When the digital image data acquired by the image-capturing operation are stored as the scene-referred raw data d1 in the recording medium of the memory device 9, the image-capturing characteristic compensation information processing section 13, having a function as the “reproduction-auxiliary data generating means”, generates the image-capturing characteristic compensation data d1 as the information required to convert the scene-referred raw data d2 into the scene-referred image data d4 of standardized color space such as RIMM RGB and ERIMM RGB, and outputs it to the header information processing section 8. The image-capturing characteristic compensation data d1 corresponds to the “reproduction-auxiliary data based on which image-capturing characteristic compensation processing is applied so as to generate the standardized scene-referred image data”.

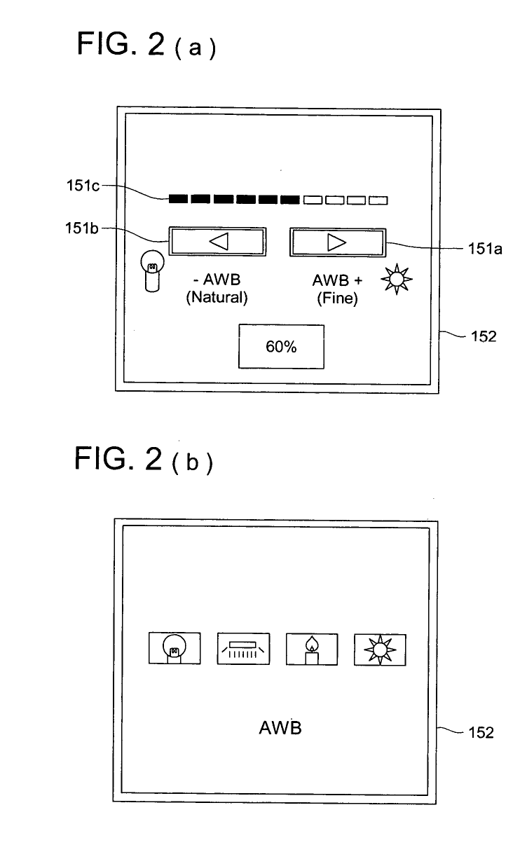

The operation section 14, having a function as the “designating means”, is provided with a touch panel that outputs positional information as input signals to control section 11 when a transparent sheet covering over the display screen of display section 15 is touched by the finger, etc. For instance, pressed signals from white-balance applying rate inputting screens 151, 152 (refer to FIG. 2(a), FIG. 2(b)) are outputted to the control section 11. Further, the operation section 14 is provided with function buttons such as a release button, power ON/OFF button and zoom button, cursor keys (not illustrated), arrow button, etc. The operation signals corresponding to buttons and keys are output to the control section 11 as input signals. In the present embodiment, the operation section 14 has a function button for specifying the output of the scene-referred raw data. Still further, the operation section 14 is provided with functional buttons for setting a record by scene-referred raw data d1 of the digital image data acquired by the image-capturing operation so that on or off state of the analog processing circuit 4 and the image-processing section 7 can be switched by the ON/OFF operation of the functional buttons.

The display section 15 displays not only the digital image data acquired by the image-capturing operation in response to the control signal sent from the control section 11, but also the inputting screen, from which the operator of image-capturing apparatus 22 inputs setting data in respect to the image-capturing operation, and the information for confirming the setting items and conditions in respect to the image-capturing operation.

FIG. 2(a) shows an example of white-balance applying rate inputting screen 151 for inputting a degree of white-balance adjustment corresponding to the user's tastes. As shown in FIG. 2(a), right arrow button 151a and left arrow button 151b are displayed in the white-balance applying rate inputting screen 151, so that one of seven stages, from “no-compensation (0%)” at which no white-balance adjustment is applied to the image signals acquired through CCD 3 and the color of the photographed light source is maintained as it is, to “maximum-compensation (100%)” at which the white-balance adjustment is fully applied to the image signals up to its maximum level, can be inputted by pushing the right arrow button 151a or the left arrow button 151b. When the right arrow button 151a is pushed once, a number of lights shown by level indicator 151c increases by one, resulting in an increase of the applying rate (%). While, when the left arrow button 151b is pushed once, a number of lights shown by level indicator 151c decreases by one, resulting in a decrease of the applying rate (%).

Alternatively, it is also applicable as another embodiment that various icons, indicating a light bulb, a fluorescent lamp, a tungsten lump (candle light), daylight, etc., are displayed in white-balance applying rate inputting screen 152 as shown in FIG. 2(b), and, when one of them is selected, the applying rate of the white-balance adjustment suitable for the selected light source is automatically set in the image-capturing apparatus.

The applying rate of the white-balance adjustment inputted from the white-balance applying rate inputting screens 151, 152 is stored in the memory device 9.

In response to the control signal coming from the control section 11, the stroboscopic drive circuit 16 drives and controls the stroboscope 17 to make it emit light when the brightness of the subject is low.

The stroboscope 17 boosts battery voltage to a predetermined level and stores it in the capacitor as electrical charge. It is driven by the stroboscopic drive circuit 16, thereby allowing an X-ray tube to emit light by electrical charge stored in the capacitor. Thus, supplementary light is applied to the subject.

In response to the control signal coming from the control section 11, the focal distance adjusting circuit 18 moves the lens 1 to control the motor 20 for adjusting the focal distance.

In response to the control signal coming from the control section 11, the automatic focus drive circuit 19 moves the lens 1 to control the motor 20 for adjusting the focus.

The applying rate data processing section 21 readouts the applying rate data stored in the memory device 9 and the photographic EV value stored in the RAM of the control section 11 to output them to the header information processing section 8.

### Operation of Image-Capturing Apparatus 21

The following describes the operations:

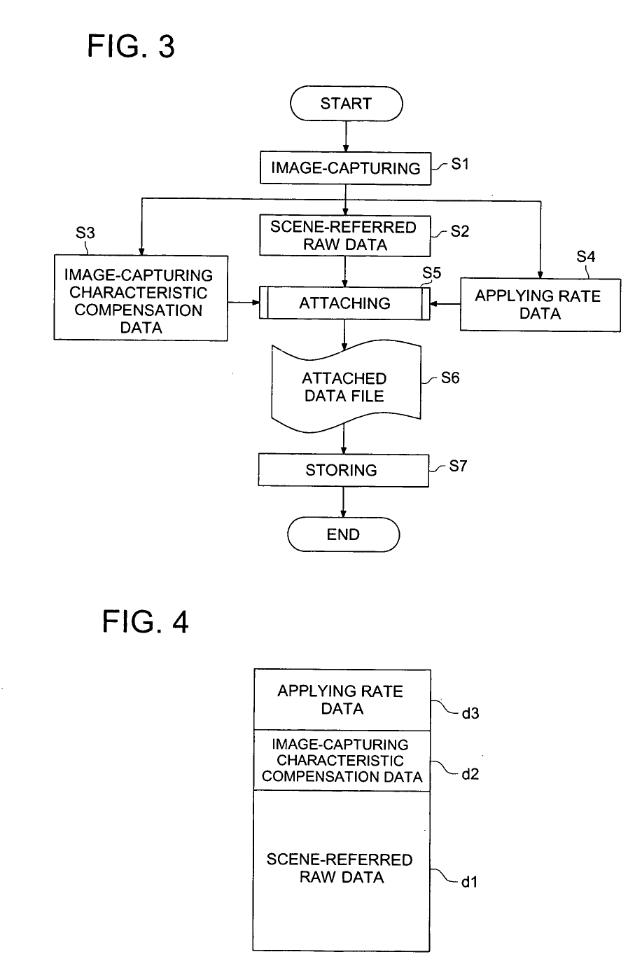

FIG. 3 is a flowchart representing the scene-referred raw data storage processing A1 to be carried out under the control of the control section 11 when the output due to scene-referred raw data d1 of the photographed digital image data is set by the operation section 14 and the release switch is pressed. The following describes the

The following describes the scene-referred raw data storage processing A1 with reference to FIG. 3:

When the release button of the operation section 14 has been pressed, the control section 11 controls various sections to carry out photographing (Step S1). The image-capturing signal obtained from the CCD3 is converted into the digital image data by the analog-to-digital converter 5, and scene-referred raw data d1 is generated (Step S2). Under the control of the control section 11, the image-capturing characteristic compensation information processing section 13 generates the data required to apply image-capturing characteristic compensation processing to the generated scene-referred raw data d1, namely image-capturing characteristic compensation data d2 (Step S3). Further, applying rate data processing section 21 readouts the applying rate data for the white-balance adjustment from the memory device 9 to generate the applying rate data d3 as well as the photographic EV value stored in the RAM (Step S4).

Under the controlling operations of the control section 11, the image-capturing characteristic compensation data d2 and the applying rate data d3 are outputted to the header information processing section 8. In the header information processing section 8, the image-capturing characteristic compensation data d2 and the applying rate data d3 are attached to the file header of the scene-referred raw data d1 as tag information (Step S5) so as to create an attached data file (Step S6). The attached data file is stored in the recording medium of the memory device 9, which is detachable in respect to the image-capturing apparatus 22 (Step S7).

FIG. 4 is a diagram representing the configuration of the digital image data recorded on the recording medium of a memory device 9 in step S7. As shown in FIG. 4, the photographed digital image data is recorded as scene-referred raw data d1 and image-capturing characteristic compensation data d2 and applying rate data d3 are recorded in this header area. This recording medium is taken out of the image-capturing apparatus 22 and is mounted on an external apparatus such as image processing apparatus and image recording apparatus, whereby the scene-referred raw data d1 and image-capturing characteristic compensation data d2 and applying rate data d3 can be outputted to these external apparatuses.

As described above, the image-capturing apparatus 22 shown in FIG. 1 makes it possible to output:

(1) scene-referred raw data d1 as an direct raw output signal of the image-capturing apparatus faithfully recording the information of a subject, wherein there is omission of image processing of intentionally modifying the contents of data to improve the effect in viewing the image such as white-balance adjustment, conversion of gradation, and enhancement of sharpness and color saturation, and the processing of mapping signal enhancement of each color channel based on the spectral sensitivity inherent to the image-capturing device, into the above-mentioned standardized color space such as RIMM RGB and sRGB; and

(2) image-capturing characteristic compensation data d2 and applying rate data d3 which indicates the degree of the white-balance adjustment based on the photographer's tastes wherein the spectral sensitivity inherent to the image-capturing device or the matrix coefficient to be used for conversion into the standardized color space such as RIMM RGB and sRGB are written. At the same time, the above-mentioned image-capturing apparatus 21 omits processing of conversion into the scene-referred image data in the image-capturing apparatus, thereby reducing the processing load and power consumption of the image-capturing apparatus, improving the processing (photographing) capability and increasing the number of sheets to be processed (shot) in the battery mode.

### Configuration of Image-Capturing Apparatus 22

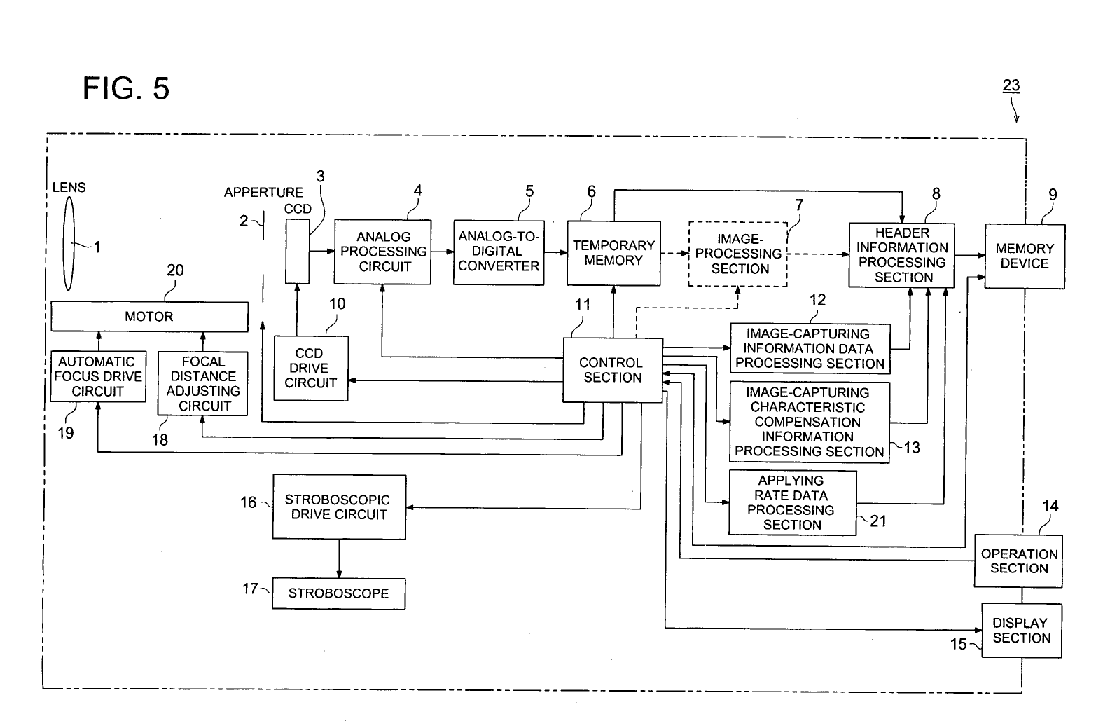

The following describes the image-capturing apparatus 23 characterized in that an image-capturing information data processing section 12 is added to the configuration of the image-capturing apparatus 22 in order to get the more preferred image where digital image data is outputted. FIG. 5 is a block diagram representing the functional configuration of an image-capturing apparatus 23.

The image-capturing information data processing section 12, having a function of image-capturing information generating means, generates image-capturing information data d4 indicating information pertaining to the type of the subject and the photographic condition settings, such as, for instance, a name and a code number of the camera, information directly pertaining to the camera type, an exposure time, a shutter speed, an aperture value (F number), ISO sensitivity, a brightness value, distance range of the subject, light source, presence or absence of the strobe lighting, a subject area, white-balance, zooming magnification, structure of the subject, type of the photographed scene, reflection light amount of the strobe light source, photographed color saturation, etc. Incidentally, since the configuration of image-capturing apparatus 23 other than image-capturing information data processing section 12 is the same as that of image-capturing apparatus 22, explanations for the same blocks will be omitted in the following.

### Operation of Image-Capturing Apparatus 23

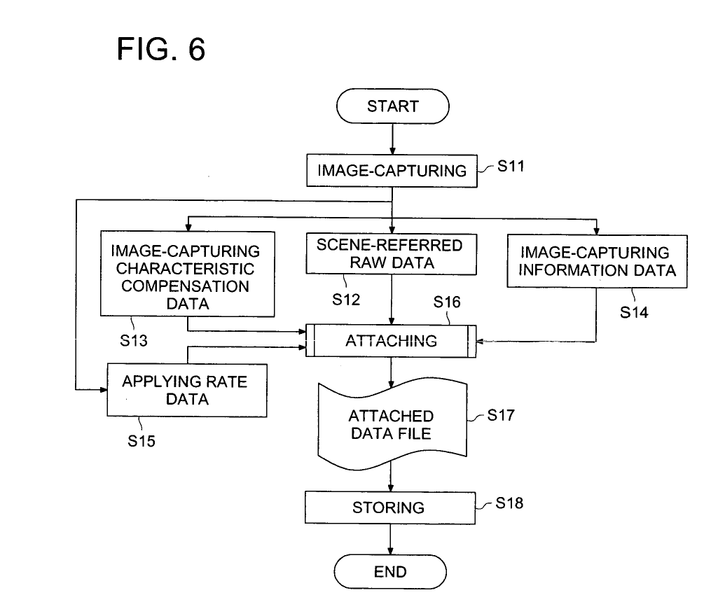

FIG. 6 is a flowchart representing the scene-referred raw data storage processing B1 to be carried out under the control of the control section 11 when the output based on the scene-referred raw data d1 of the photographed digital image data is set by the operation section 14 and the release switch is depressed. The following describes the scene-referred data storage processing B1 with reference to FIG. 6:

When the release button of the operation section 14 is depressed, the control section 11 controls various sections to start photographing (Step S11). The image-capturing signal obtained from the CCD3 is converted into the digital image data by the analog-to-digital converter 5 and the scene-referred raw data d1 is generated (Step S12). Image-capturing characteristic compensation data d2 is generated by the image-capturing characteristic compensation information processing section 13 (Step S13), and image-capturing information data d4 is generated by the image-capturing information data processing section 12 (Step S14). Further, the applying rate data are readout from the memory device 9 by the applying rate data processing section 21 so as to generate applying rate data d3 as well as the photographic EV value (Step S15).

The image-capturing characteristic compensation data d2, the applying rate data d3 and the image-capturing information data d4 are outputted to the header information processing section 8. In the header information processing section 8, the image-capturing characteristic compensation data d2, the applying rate data d3 and the image-capturing information data d4 are recorded and attached into the file header of the scene-referred raw data d1 (Step S16), to create the attached data file (Step S17), which is stored in the recording medium of the memory device 9 detachably mounted in image-capturing apparatus 23 (Step S18).

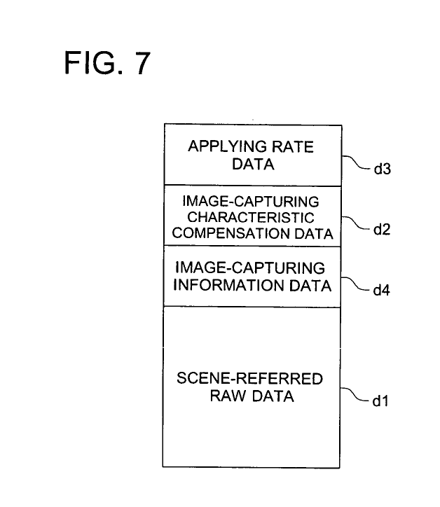

FIG. 7 is a diagram representing the data configuration of the digital image data recorded on the recording medium of a storage device 9 in step S18. As shown in FIG. 7, the photographed digital image data is recorded as scene-referred raw data d1, and image-capturing characteristic compensation data d2, applying rate data d3 and image-capturing information data d4 are recorded in the header area. When this recording medium is removed from the image-capturing apparatus 23 and is mounted on the external device such as image processing apparatus and image recording apparatus, scene-referred raw data d1, image-capturing characteristic compensation data d2, applying rate data d3 and image-capturing information data d4 can be output to these external devices.

As described above, in addition to the effect of the image-capturing apparatus 22, the image-capturing apparatus 23 is capable of outputting the data that allows generation of the output-referred image data in response to a particular photographed condition in the external output apparatus.

### Configuration of Image Processing Apparatus 115

The following describes the embodiment of the image processing apparatus of the present invention:

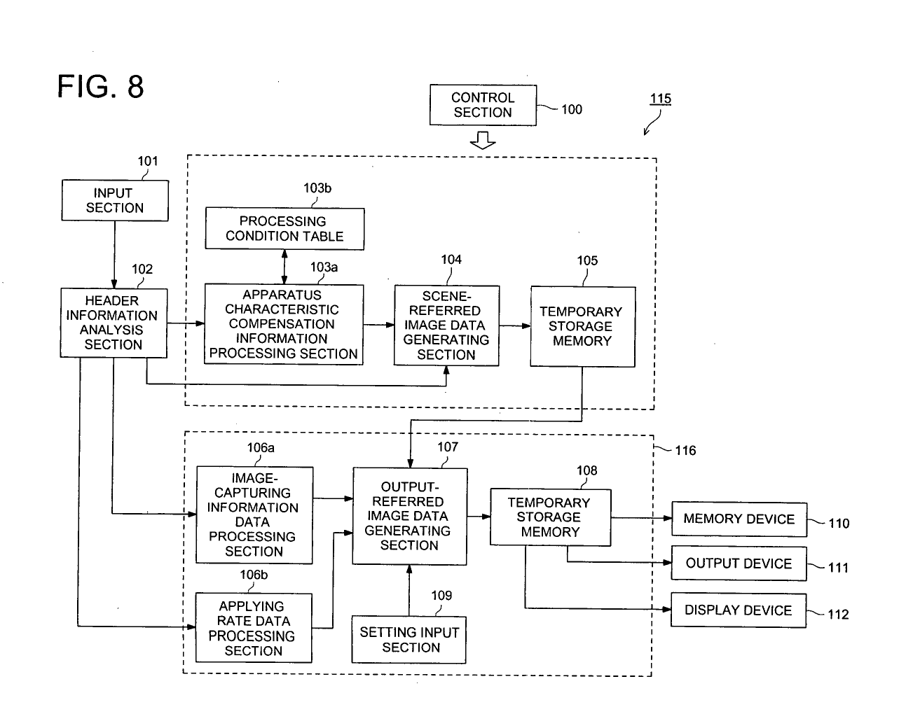

FIG. 8 is a block diagram representing the functional configuration of an image processing apparatus 115 of the present invention. As shown in FIG. 8, the image processing apparatus 115 comprises:

an input section 101,

a header information analysis section 102,

an image-capturing characteristic compensation information processing section 113 for generating the scene-referred image data d5 by the step wherein image-capturing characteristic compensation processing is applied to the scene-referred raw data d1 based on the image-capturing characteristic compensation data d2, and

an optimization processing section 114 for generating the output-referred image data d6 by the step where optimization processing is applied to the scene-referred image data d5 generated by the image-capturing characteristic compensation information processing section 113. The image-capturing characteristic compensation information processing section 113 and optimization processing unit 114 are each connected with the header information analysis section 102. The optimization processing unit 114 is further made ready for connection with a memory device 110, output device 111 and display device 112. These components are operated under the total controlling actions of the control section 100, which is constituted by the CPU and its controlling programs, the ROM storing various kinds of processing programs including the processing program for the raw image data, etc.

The input section 101, serving as an inputting means, has a recording medium mounting section (not illustrated). When the recording medium for recording the file (refer to FIGS. 4 and 7) of the data photographed by the image-capturing apparatuses 22 and 23 is installed on this mounting section, the input section 101 reads the recorded data file, and outputs it to the header information analysis section 102. The present embodiment will be described on the assumption that the input section 101 reads data from the mounted recording media. It would be also applicable, however, that the image-capturing apparatuses 22 and 23 are coupled to other apparatus through a data communicating cable or communicating means being either a wireless or a wired line, to input the data.

The header information analysis section 102 analyzes the data inputted from the input section 101 to divide the data into scene-referred raw data d1, image-capturing characteristic compensation data d2 attached to scene-referred raw data d1, applying rate data d3 and image-capturing information data d4, and then, sends scene-referred raw data d1 to the scene-referred image data generating section 104, image-capturing characteristic compensation data d2 to apparatus characteristic compensation information processing section 103a, applying rate data d3 to the applying rate data processing section 106b and image-capturing information data d4 to the image-capturing information data processing section 106a.

The image-capturing characteristic compensation information processing section 113 serves as a scene-referred image data generating means, and is constituted by the image-capturing characteristic compensation processing section 103a, the processing condition table 103b, the scene-referred image data generating section 104 and the temporary storage memory 105.

When the image-capturing characteristic compensation data d2 is inputted from the header information analysis section 102, the apparatus characteristic compensation information processing section 103a determines the conditions for generating the scene-referred image data d5 by reference to the processing condition table 103b. The processing condition table 103b associates processing conditions for generating scene-referred image data d5 for each characteristic of the image-capturing apparatus and stores them in the memory.

The scene-referred image data generating section 104 applies image-capturing characteristic compensation processing to scene-referred raw data d1 inputted from the header information analysis section 102, based on the generating conditions determined by the apparatus characteristic compensation information processing section 103a. It generates the standardized scene-referred image data d5 independent of the image-capturing characteristic, and outputs it to the temporary storage memory 105. To put it more specifically, image-capturing characteristic compensation processing comprises at least the processing of mapping the signal intensity of the signal of each color channel based on the spectral sensitivity inherent to the image-capturing device of the image-capturing apparatus having generated the scene-referred raw data d1, into the standardized color space such as RIMM RGB and ERIMM RGB. The temporary storage memory 105 temporarily stores the scene-referred image data d5 generated by the scene-referred image data generating section 104.

As shown in FIG. 8, the optimization processing section 114, serving as a scene-referred image data generating means, is constituted by the image-capturing information data processing section 106a, the applying rate data processing section 106b, the output-referred image data generating section 107, the temporary storage memory 108 and the setting input section 109.

The image-capturing information data processing section 106a determines the conditions for generating the output-referred image data d6 in conformity to photographing conditions, based on the image-capturing information data d4 inputted from the header information analysis section 102.

The applying rate data processing section 106b, serving as a applying rate determining means, determines conditions for the white-balance adjustment, based on applying rate data d3 inputted from the header information analysis section 102.

The setting input section 109 includes, for instance, a keyboard, a mouse, etc., and, when the operating information with respect to a kind of the memory device 110, the output device 111 and the display device 112 are inputted, outputs them to the output-referred image data generating section 107. Further, it is also applicable that the setting input section 109 includes a touch panel which outputs positional information, inputted by touching a transparent sheet panel covering over the display screen of the display device 112 with a finger or a stylus pen, to output the positional information as inputted signals.

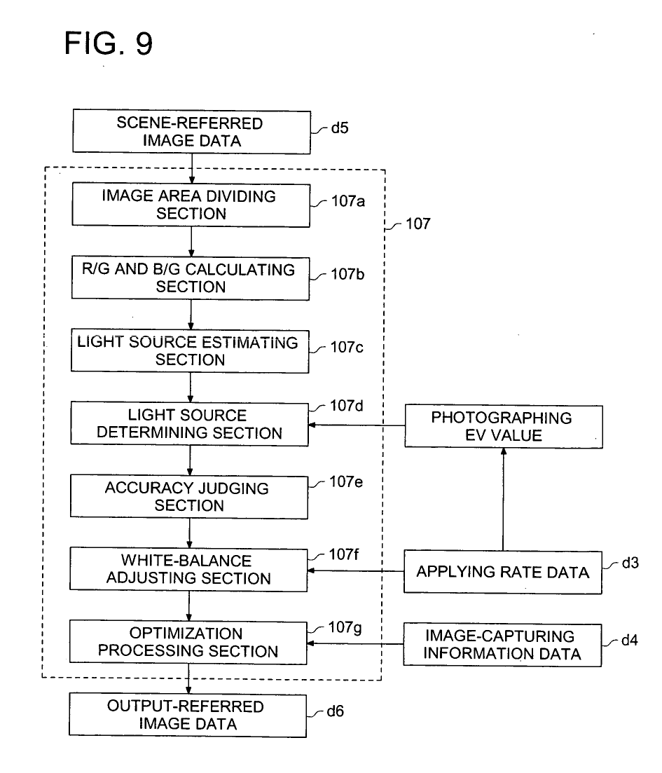

As shown in FIG. 9, the output-referred image data generating section 107 includes an image area dividing section 107a, a R/G and B/G calculating section 107b, a light source estimating section 107c, a light source determining section 107d, an accuracy judging section 107e, a white-balance adjusting section 107f and an optimization processing section 107g, and generates output-referred image data d6 by applying an image processing to scene-referred image data d5, based on image-processing conditions created by image-capturing information data processing section 106a, processing conditions of the white-balance adjustment created by applying rate data processing section 106b and a type of outputted apparatus inputted from the setting input section 109. Incidentally, the sections from the image area dividing means 107a to the white-balance adjusting section 107f also apply the white-balance adjustment to scene-referred image data d5, and therefore, have a function of white-balance adjusting means.

The temporary storage memory 108 temporarily stores output-referred image data d6 inputted from the output-referred image data generating section 107 under the controlling operations of the control section 100. According to the operating information inputted from the setting input section 109, the output-referred image data d6 are outputted to anyone of the memory device 110, the output device 111 and the display device 112.

### Operation of Image Processing Apparatus 115

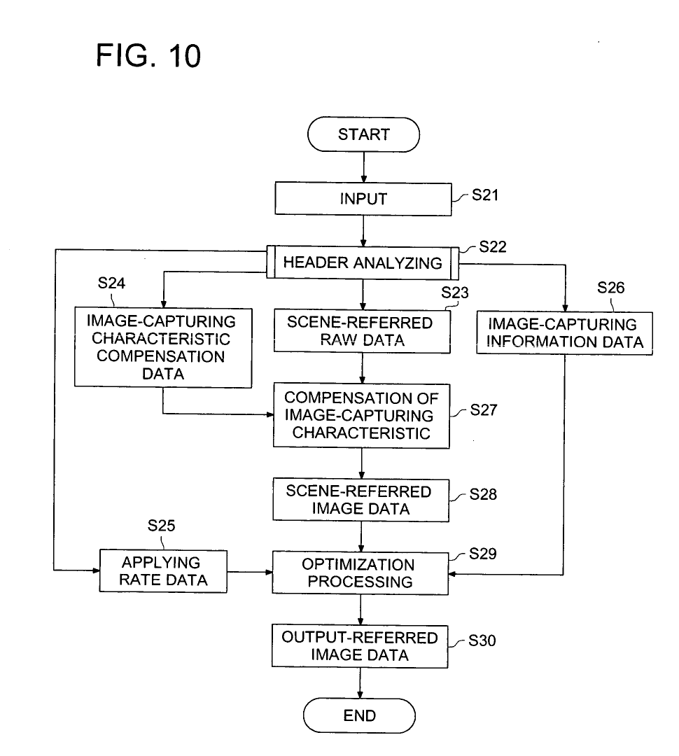

FIG. 10 is a flowchart representing image data generation processing to be carried out by interconnection among various parts of the image processing apparatus 115 under the controlling operations of the control section 100. The following describes the operation of image processing apparatus 115 with reference to drawings:

When the recording medium storing the digital image data file having a data structure given in FIG. 4 or FIG. 7 has been mounted in position, the digital image data file stored in the recording medium is inputted by the input section 101 (Step S21). The contents of the inputted digital image data are analyzed by the header information analysis section 102 (Step S22) and are divided into scene-referred raw data d1 (Step S23), image-capturing characteristic compensation data d2 (Step S24), applying rate data d3 (Step S25) and image-capturing information data d3 (Step S26). Scene-referred raw data d1 and image-capturing characteristic compensation data d2 are output to the image-capturing characteristic compensation information processing section 113, and, applying rate data d3 and the image-capturing information data d4 are outputted to the optimization processing section 114.

When image-capturing characteristic compensation data d2 is inputted to the image-capturing characteristic compensation information processing section 113, the processing condition table 103b is referenced by the apparatus characteristic compensation information processing section 103a to determine the processing conditions for generating scene-referred image data d5. Scene-referred raw data d1 is subjected to image-capturing characteristic compensation information processing through the scene-referred image data generating section 104 based on these conditions (Step S27). Then scene-referred image data d5 is generated and is outputted to the optimization processing section 114 (Step S28).

When the image-capturing information data d4 is inputted to the optimization processing section 114, processing conditions for generating output-referred image data d6 in conformity to photographing conditions are determined by image-capturing information data processing section 106a, based on the image-capturing information data d4. Further, when applying rate data d3 is inputted to the optimization processing section 114, processing conditions for the white-balance adjustment are determined by applying rate data processing section 106b. The scene-referred image data d5 entered from the image-capturing characteristic compensation information processing section 113 is subjected to optimization processing in conformity to the output destination through the output-referred image data generating section 107, based on the processing conditions determined by the output-referred image data generating section 107 and image-capturing information data processing section 106a, the processing conditions for the white-balance adjustment determined by applying rate data processing section 106b and the operation information inputted from the setting input section 109 (Step S29). Then output-referred image data d6 is generated and is outputted by the setting input section 109 (Step S30).

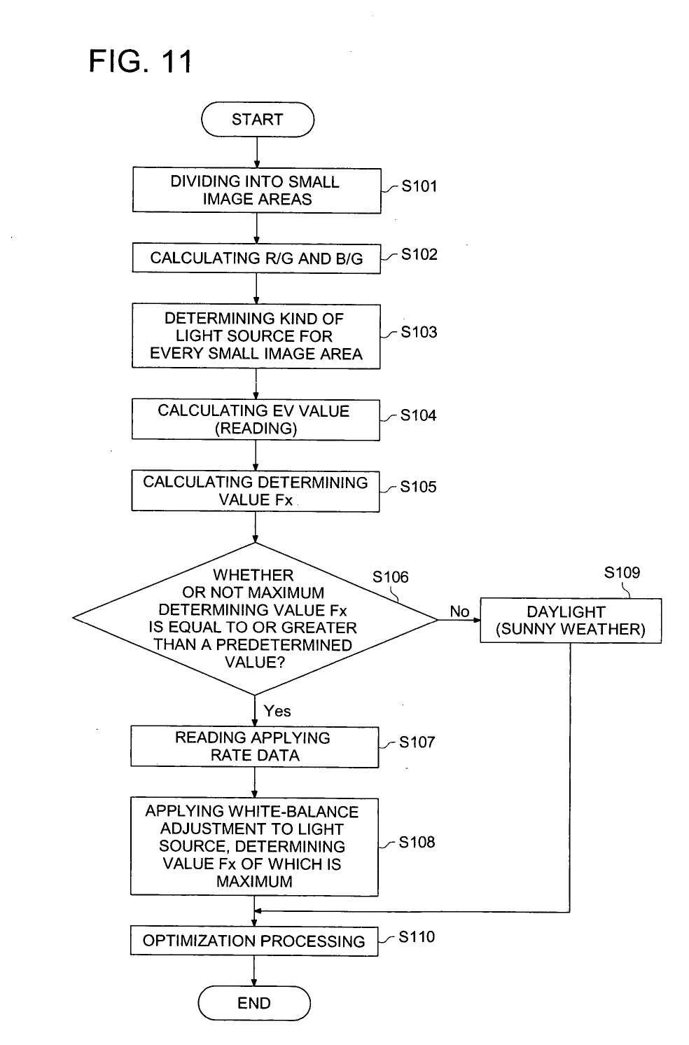

FIG. 11 shows an example of the optimization processing A2 executed by output-referred image data generating section 107 in Step S29. In this example, a white-balance adjusting method in which the membership function is employed will be described. Referring to the block diagram and the flowchart of the output-referred image data generating section 107 shown in FIG. 9 and FIG. 11, the optimization processing A2 will be detailed in the following.

When scene-referred image data d5 is inputted into output-referred image data generating section 107, the image area dividing section 107a divides a whole image area of scene-referred image data d5 into a plurality of small image areas (Step S101). A desirable dividing method is to divide it into “m” segments in its vertical direction and “n” segments in its horizontal direction, and totally “m”×“n”=“k” number of small image areas, each being a rectangular shape. Further, it is also desirable that “k” is in a range of 4-36.

Next, for a respective one of the small image areas, the R/G and B/G calculating section 107b calculates an average integrated value for each of primary colors, so as to calculate a R/G ratio representing a ratio between an integrated value of R (Red) signals and an integrated value of G (Green) signals, and a B/G ratio representing a ratio between an integrated value of B (Blue) signals and an integrated value of G (Green) signals (Step S102).

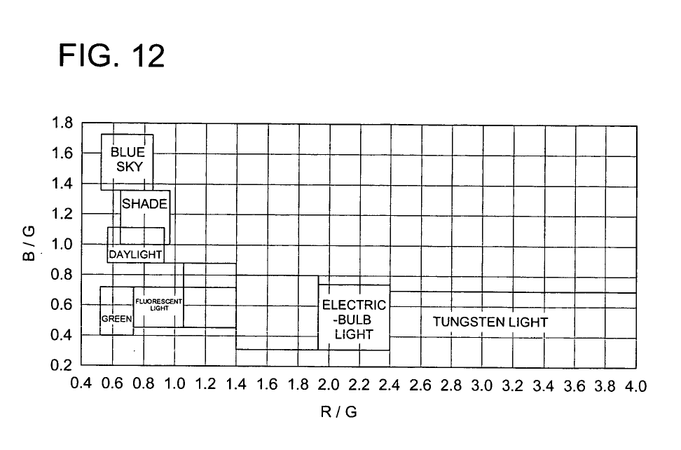

The light source estimating section 107c conducts the estimation processing of the photographic light source for every small image area by plotting the R/G ratio and the B/G ratio calculated for a respective one of the small image areas onto a light-source estimating map in which light-source area frames are established in advance (refer to FIG. 12) (Step S103). Concretely speaking, the light source estimation for each small image area is achieved by determining a specific light-source area frame in which the R/G ratio and the B/G ratio calculated for a respective one of the small image areas is actually plotted.

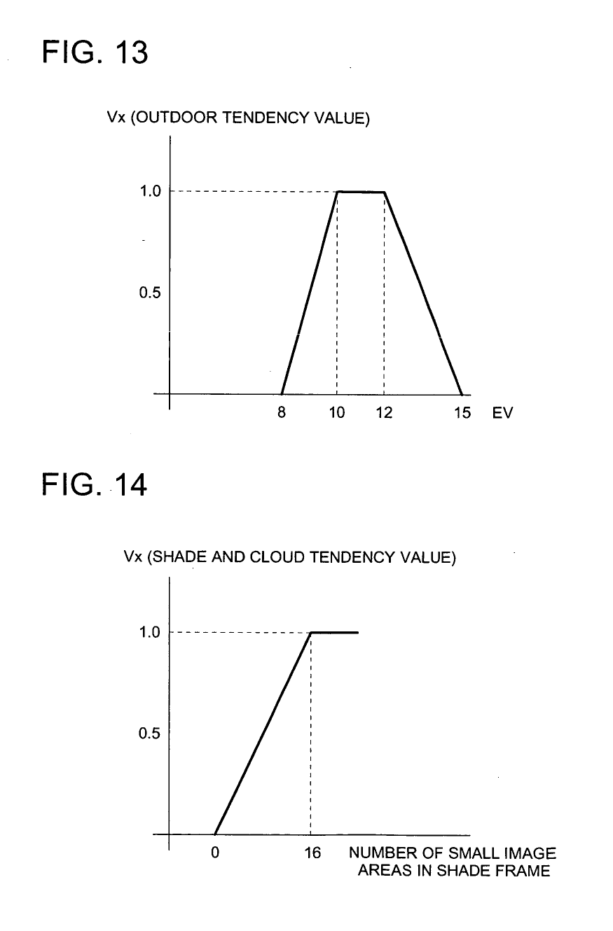

After the abovementioned estimation processing is completed, the light source determining section 107d conducts the determination processing of the photographic light source. In the determination processing, the photographic EV value is readout from the applying rate data processing section 106b or calculated (Step S104), and the determining value Fx is calculated by employing a membership function in which a tendency value Vx is defined with the photographic EV value as a variable, or another membership function in which a tendency value Vx is defined with a number of small image areas for every kind of light source obtained by the abovementioned estimation processing as a variable (Step S105). FIG. 13 shows a membership function in which a tendency value Vx (outdoor tendency value) is defined, as an example of the membership function in which the tendency value Vx is defined with the photographic EV value as a variable. Further, FIG. 14 shows a membership function in which a tendency value Vx (shade-cloudiness tendency value) is defined, as an example of the membership function in which the tendency value Vx is defined with the number of small image areas for every kind of light source obtained by the abovementioned estimation processing as a variable. The membership function is defined for every one of tendency values for calculating the determining values Fx, the tendency values including, for instance, an outdoor tendency value, a shade-cloudiness tendency value, a blue-sky tendency value, an indoor daylight tendency value, a fluorescent light tendency value, an indoor bulb-light tendency value, a bulb-light tendency value, etc.

The Exemplified equations for calculating the determining values Fx by using the tendency value Vx obtained from each of the membership functions are indicated in the following.

F1=V1 * V2 * V3 (1)

where, F1: shade-cloudiness determining value,

V1: outdoor tendency value,

V2: shade-cloudiness tendency value,

V3: blue-sky tendency value.

F2=V4 * V5 (2)

where, F2: daylight determining value,

V4: indoor daylight tendency value,

V5: fluorescent light tendency value.

F3=V6 * V5 * V7 (3)

where, F3: tungsten determining value,

V6: indoor bulb-light tendency value,

V5: fluorescent light tendency value,

V7: bulb-light tendency value.

Incidentally, it is desirable that each equation for calculating the determining value Fx is established for each kind of the light source for which the light-source area frame is set on the light-source estimating map shown in FIG. 12. In the embodiment of the present invention, each equation for calculating the determining value Fx is established for each kind of the light source on the light-source estimating map.

Successively, the accuracy judging section 107e determines whether or not the maximum value of the determining value Fx is equal to or greater than a predetermined value (Step S106). When determining that the maximum value of the determining value Fx is equal to or greater than the predetermined value, the accuracy judging section 107e judges that the light source of the maximum value of the determining value Fx is the kind of the photographed light source, and the processing shifts to Step S107. When determining that all of the determining values derived from all calculating equations are lower than the predetermined value, the accuracy judging section 107e judges that the light source concerned is daylight (Step S109), and the processing shifts to Step S110 without conducting the white-balance adjustment for scene-referred image data d5.

In Step S107, the white-balance adjusting section 107f reads applying rate data d3 (Step S107), to apply the application amount of the white-balance adjustment to scene-referred image data d5, based on applying rate data d3 corresponding to the kind of light source determined in the above Step (Step S108).

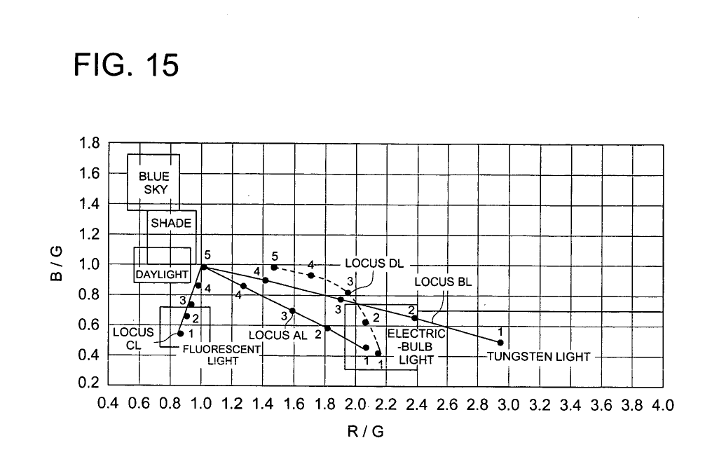

FIG. 15 shows locus of the white-balance adjustment based on the position of the light source estimated on the light source estimating map and the applying rate data. The locus AL indicates the white-balance adjusting locus for the electronic-bulb light source, while the locus BL indicates that for the tungsten light source, both based on applying rate data d3.

The points attached with numerals, plotted on the locus AL, BL shown in FIG. 15, indicate converging points of the white-balance adjustment at each of inputted points, when the image-capturing apparatus 22, 23, embodied in the present invention, inputs the applying rate data in a stepwise mode of five stages. The plotted points 1, 2, 3, 4, 5 correspond to the converging points 0%, 25%, 50%, 75%, 100%, respectively. In FIG. 15, when the “applying rate data” indicate the maximum value, (R/G, B/G)=(1, 1)=plotted point 5 is established, while, when the “applying rate data” indicate the minimum value, the coordinate of (R/G, B/G) is not changed from the estimated light source position (namely, plotted point 1).

The converting operation, from the position of the light source estimated on the light source estimating map to the plotted point 5 at which white-balance is adjusted at maximum, is conducted by employing the function Fu defined in advance. The white-balance adjustment is conducted according to the following equations, which employ white-balance compensation amounts (n1, n2, n3) calculated by the function Fu.

R′=n1 * R, G′=n2 * G, B′=n3 * B (4)

where, R, G, B: original image signals,

R′, G′, B′: image signals after the white-, balance adjustment.

Accordingly, the relationship between value “m” of the applying rate data and the compensation amount of the white-balance adjustment can be expressed by the following equations.

R′=m * n1 * R, G′=m * n2 * G, B′=m * n3 * B (5)

Incidentally, although the applying rate data processing section 106b determines the relationship between value “m” of the applying rate data and the compensation amount (applying amount) of the white-balance adjustment, it is possible to arbitrarily establish the relationship between applying rate data d3 and the applying amount of the actual white-balance adjustment as mentioned in the above. For instance, other than the case of applying the applying amount in proportion to the value of applying rate data d3 while assuming that the applying rate data in case of applying the full white-balance adjustment to scene-referred image data d5 is 100%, the applying rate of the actual white-balance adjustment is increased or decreased according as the value of applying rate data d3 increases.

The locus CL shown in FIG. 15 indicates the white-balance adjusting locus based on applying rate data d3 of the fluorescent light source. The locus DL shown in FIG. 15 indicates the white-balance compensating pattern with a priority weight for the human's skin color based on applying rate data d3 of the bulb light source. The converging point (plotted point 5) at the time when applying rate data d3 is maximum does not fulfill the equation of (R/G, B/G)=(1, 1). As described in the above, it is acceptable that the locus is not necessary linear, or the converging point does not necessary fulfill the equation of (R/G, B/G)=(1, 1).

After the white-balance adjustment is applied, the optimization processing section 107g applies the optimization processing to scene-referred image data d5, corresponding to the type of the output device, based on the image processing conditions determined by the image-capturing information data processing section 106a and the operating information inputted from the setting input section 109 (Step S110). The optimization processing includes, for instance, compression of the color range corresponding to the output device, compression of the gradation from 16 bits to 8 bits, reduction of the output pixel number and processing operation for the output characteristics (LUT) of the output device and the display device. In addition, the optimization processing further includes various image-processing operations, such as noise reduction, sharpness conversion, color-balance adjustment, color-saturation adjustment, dodging processing, etc.

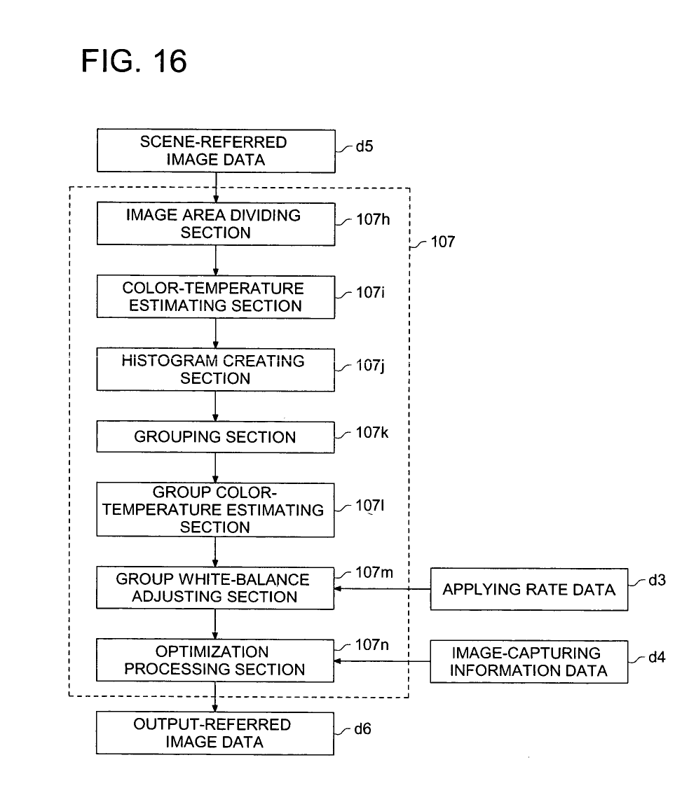

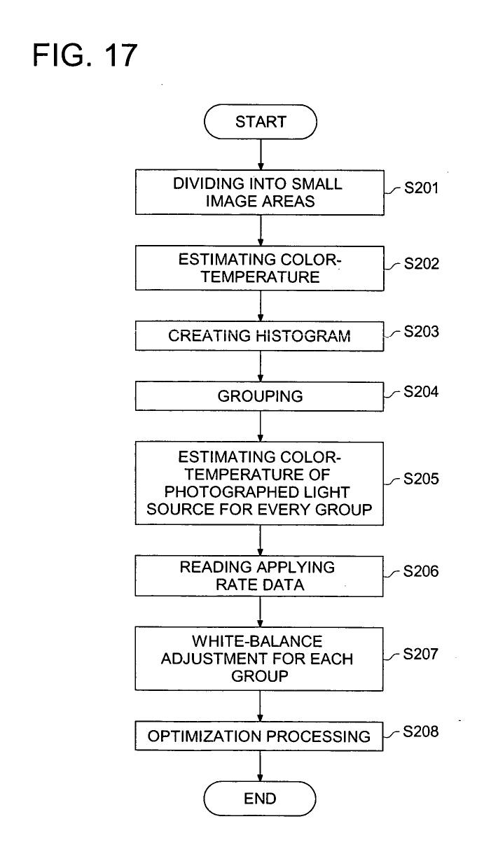

According to the processing described in the above, output-referred image data d6 are generated from scene-referred image data d5. Incidentally, the method of white-balance adjustment is not limited to the abovementioned method employing the membership function. FIG. 16 shows an internal configuration of another output-referred image data generating section 107 employing another white-balance adjusting method, which adjusts the white-balance by estimating a color temperature for every small image area. Incidentally, the sections from an image area dividing section 107h to a group white-balance adjusting section 107m also apply the white-balance adjustment to scene-referred image data d5, and therefore, have a function of white-balance adjusting means. Further, FIG. 17 shows an example of optimization processing B1 including the white-balance adjustment. Referring to FIG. 16 and FIG. 17, the optimization processing B1 will be detailed in the following.

When scene-referred image data d5 is inputted into output-referred image data generating section 107, the image area dividing section 107h divides a whole image area of scene-referred image data d5 into a plurality of small image areas (Step S201). A desirable dividing method is to divide it into “m” segments in its vertical direction and “n” segments in its horizontal direction, and totally “m”×“n”=“k” number of small image areas, each being a rectangular shape. Further, it is also desirable that “k” is in a range of 4-36.

Successively, the color-temperature estimating section 107i conducts an estimation processing for estimating color-temperature Te for every small image area, with respect to each of the plurality of small image areas (Step S202). The color-temperature estimating method will be described in the following.

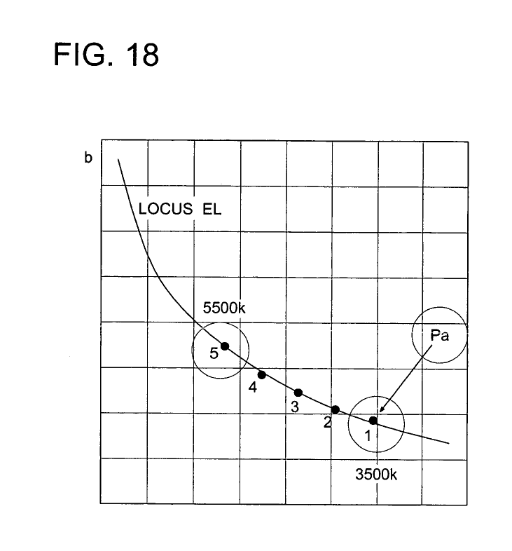

At first, the image signals (R, G, B), acquired by capturing a gray image under, for instance, the light source having the color temperature of 3500K, are converted to the chromaticity coordinates (r, b), which are plotted on the chromaticity diagram shown in FIG. 18, by employing equation (6) shown below.

r=R/(R+G+B), b=B/(R+G+B) (6)

The locus EL shown in FIG. 18 indicates a blackbody radiation locus of gray color. In case that the white-balance adjustment is not applied to the digital image data in the image-capturing apparatus, namely the case that the digital image data inputted from the image-capturing apparatus are, for instance, scene-referred raw data d1, or in case that the automatic white-balance function of the image-capturing apparatus is normally worked, the abovementioned chromaticity coordinates (r, b) should be plotted in the vicinity of 3500K shown in FIG. 18. However, when the chromaticity coordinates (r, b) is plotted onto a position located within region Pa shown in FIG. 18, which is apart from the position of 3500K, there is a possibility that the automatic white-balance function of the image-capturing apparatus is not normally worked.

The signals R′, G′, which are obtained by applying a primary conversion to the image signals R, G, according to equation (7) shown below, is compared with the blackbody radiation locus of gray color, so as to detects pixels in the vicinity of the blackbody radiation locus (for instance, a predetermined range on the chromaticity coordinates (r, b)) as candidate pixels of gray color. The values of coefficients r1, r2 are optimized, so as to make a number of the candidate pixels of gray color maximum by counting the candidate pixels.

R′=r1 * R, G′=r2 * G (7)

Further, the image signals are converted by employing the optimized values of coefficients r1, r2, and color temperature Te is estimated by calculating an average color temperature of the candidate pixel group of gray color on the blackbody radiation locus of gray color.

For instance, the least square method can be cited as the optimizing method. The least square method can be classified into a linear type and a nonlinear type, and, as the latter method, there have been well known the quasi-Newton method, Gauss-Newton method, Marcate method, etc. When the nonlinear least square method is employed, the optimization for searching a minimum point would be conducted, since it is impossible to find a solution with a finite number of means, being different from the case employing the linear type. Although there have been well known, the Simplex method and the Dabidon-Flecher-Powell method (DFP method) as an example of this optimizing method, it is desirable that the Simplex method of the former is employed for the embodiment of the present invention.

Next, the histogram creating section 107j creates an emergency frequency histogram of the color temperature Te estimated for every small image area (Step S203).

Next, the grouping section 107k selects two peaks out of the peaks on the histogram in higher-level order, and calculates an intermediate color temperature Tm between the two peaks, and then, groups the plurality of small image areas into two groups, corresponding to whether or not the color temperature Te of each of the plurality of small image areas is greater than the intermediate color temperature Tm (Step S204). Incidentally, although an example of grouping the plurality of small image areas into two groups is explained in the above, the number of peaks to be selected and the number of groups to be grouped are not limited to those in the above example.

Next, the group color-temperature estimating section 107l conducts a secondary determination processing for estimating the color temperatures Ts1, Ts2 for every group of the small image areas, which are divided into two groups by employing the abovementioned intermediate color temperature Tm as a parameter (Step S205).

Then, the group white-balance adjusting section 107m reads applying rate data d3 (Step S206), and calculates a white-balance compensation amount for every group, based on the color temperatures Ts1, Ts2 estimated for each of the groups, in order to apply the white-balance adjustment to all of the small image areas for every group (Step S207). According to the abovementioned method, even for a scene captured under a mixture of light sources, it is possible to apply the white-balance adjustment for every captured image area irradiated by each of the light sources.

The points attached with numerals, plotted on the locus EL shown in FIG. 18, indicate converging points of the white-balance adjustment at each of inputted points, when the image-capturing apparatus 22, 23, embodied in the present invention, inputs the applying rate data in a stepwise mode of five stages. The plotted points 1, 2, 3, 4, 5 correspond to the converging points 0%, 25%, 50%, 75%, 100%, respectively. In FIG. 18, when the “applying rate data” indicate the maximum value, the converging point is plotted point 5, while, when the “applying rate data” indicate the minimum value, the converging point is not changed from the position of the estimated color temperature (plotted point 1). The plotted point 5 is located at the standard color temperature of 5000K.

The converting operation, from the estimated color temperatures Ts1, Ts2 to 5500K, is conducted by employing the color temperature function Ft defined in advance. The white-balance adjustment is conducted according to the following equations, which employ white-balance compensation amounts (t1, t2, t3) calculated by the color temperature function Ft.

R″=t1 * R, G″=t2 * G, B″=t3 * B (8)

where, R, G, B: original image signals,

R″, G″, B″: image signals after the white-, balance adjustment.

Accordingly, the relationship between value “s” of the applying rate data and the compensation amount of the white-balance adjustment can be expressed by the following equations.

R″=s * t1 * R, G″=s * t2 * G, B″=s * t3 * B (9)

Incidentally, although the applying rate data processing section 106b determines the relationship between value “s” of the applying rate data and the compensation amount (applying amount) of the white-balance adjustment, it is possible to arbitrarily establish the relationship between applying rate data d3 and the applying amount of the actual white-balance adjustment as mentioned in the above. For instance, other than the case of applying the applying amount in proportion to the value of applying rate data d3 while assuming that the applying rate data in case of applying the full white-balance adjustment to scene-referred image data d5 is 100%, the applying rate of the actual white-balance adjustment is increased or decreased according as the value of applying rate data d3 increases.

After the white-balance adjustment is applied, the optimization processing section 107g applies the optimization processing to scene-referred image data d5, corresponding to the type of the output device, based on the image processing conditions determined by the image-capturing information data processing section 106a and the operating information inputted from the setting input section 109 (Step S110). The optimization processing includes, for instance, compression of the color range corresponding to the output device, compression of the gradation from 16 bits to 8 bits, reduction of the output pixel number and processing operation for the output characteristics (LUT) of the output device and the display device. In addition, the optimization processing further includes various image-processing operations, such as noise reduction, sharpness conversion, color-balance adjustment, color-saturation adjustment, dodging processing, etc.

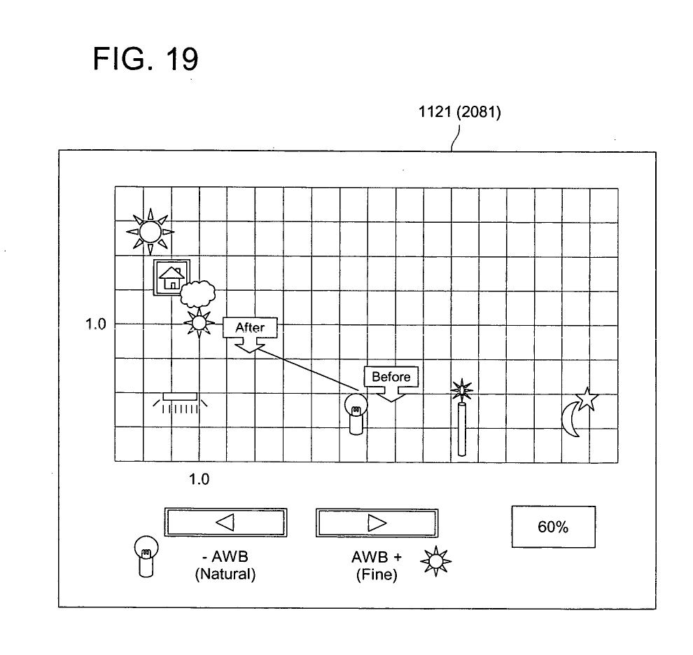

Incidentally, when implementing the present invention, a method for adjusting the white-balance and a configuration of the output-referred image data generating section 107 for implementing the method are not limited to the abovementioned methods and configurations. Further, it would be an applicable specification that the image-processing apparatus 115 can change the white-balance adjusting method to employ it. Still further, as shown in FIG. 19, it is also applicable that a white-balance applying-rate inputting screen 1121 is displayed on the display device 112 under the controlling actions of control section 100, so that the white-balance adjustment is applied, based on the applying rate inputted from the above screen. Accordingly, it becomes possible for the image-processing operator to apply the white-balance adjustment corresponding to the tastes of him or a client. Still further, as shown in FIG. 19, it would be also an applicable specification that the result of the light source estimation and the result of the white-balance adjustment based on applying rate data are displayed on the display device 112.

Further, since the setting input section 109 is provided with a function for designating the output directory of scene-referred image data d5, the image-processing apparatus 115 can output scene-referred image data d5 to an external device. When the setting input section 109 designates the output directory of scene-referred image data d5, the optimization processing and the output-referred image data generating operation, to be conducted in Steps S29, S30 of the abovementioned image data generating process shown in FIG. 10, are omitted. Alternatively the Step of generating the output data file by attaching image-capturing characteristic compensation data d2, applying rate data d3 and image-capturing information data d4 to the header area of scene-referred image data d5 generated by the image-capturing characteristic compensation information processing section 113 (a function as “output data generating means”), and the next Step of outputting the output data file to the memory device 110, the output device 111 or the display device 112, are conducted. At this time, in case that applying rate data d3 are inputted from the white-balance applying-rate inputting screen 1121 mentioned above, it is applicable that only this inputted applying rate data d3 are attached to scene-referred image data d5, or both this inputted applying rate data d3 and other applying rate data d3 designated by the photographer from the image-capturing apparatus are attached to scene-referred image data d5.

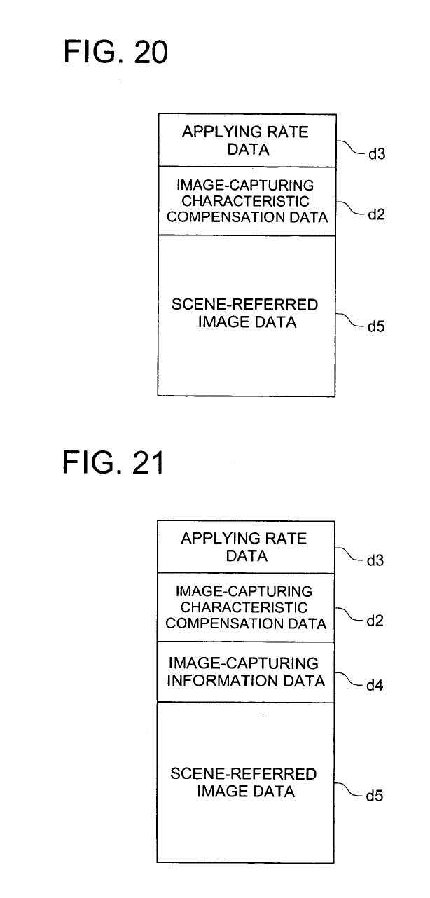

FIG. 20 is a diagram representing output data configuration for generating scene-referred image data d5 and outputting it to the memory device 110 when a file having data configuration of FIG. 4 has been inputted from the input section 101. FIG. 21 is a diagram representing output data configuration for generating scene-referred image data d5 and outputting it to the memory device 110 when a file having data configuration of FIG. 7 has been inputted from the input section 101. When such a memory device 110 is mounted on an external apparatus such as a display device and image recording apparatus, the scene-referred image data d5 and image-capturing characteristic compensation data d2, applying rate data d3 (and image-capturing information data d4) can be outputted to the external apparatus, which is allowed to carry out optimization processing in conformity to its own apparatus conditions.

Further, it is possible to input the file, in which applying rate data d3 and image-capturing information data d4 are attached to scene-referred image data d5, into the input section 101. In this case, the processing to be conducted in image-capturing characteristic compensation information processing section 113 is omitted, and only the processing in the optimization processing section 114 is conducted.

As described above, scene-referred image data d5 is generated from the scene-referred raw data d1 outputted from the image-capturing apparatuses 22 and 23 by the image processing apparatus 115. Optimized output-referred image data d6 can be created without losing the captured image information, so that it is outputted onto such a display device as CRT, liquid crystal display and plasma display, and a storage medium of any known type such as paper for generation of hardcopy images including silver halide photographic paper, inkjet paper and thermal printing paper. At this time, it is possible to apply an applying amount of the white-balance adjustment, which corresponds to the tastes of the photographer at the time of capturing the image concerned or the tastes of the operator of the image-processing apparatus 115, to scene-referred image data d5 based on applying rate data d3. Further, since it is also possible to output scene-referred image data d5 associated with image-capturing characteristic compensation data d2, applying rate data d3 and image-capturing information data d4, it becomes possible to utilize the digital image data, outputted from the image-capturing apparatus 22, 23, for printing the image concerned in the home environment or the office environment without losing the captured image information.

### Configuration of Image Recording Apparatus 201

The following describes the preferred embodiments of the image recording apparatus of the present invention:

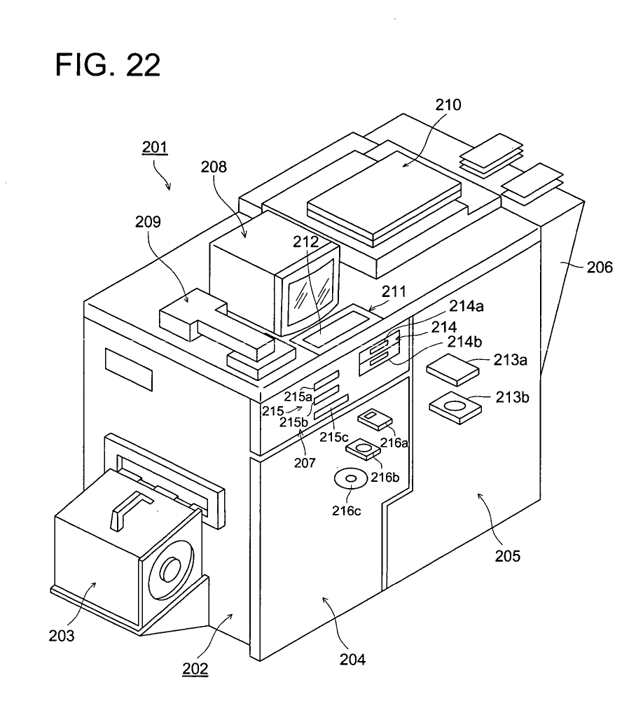

FIG. 22 is an external perspective view representing an image recording apparatus 201, embodied in the present invention. The image recording apparatus 201 in the present embodiment provides an example of the image recording apparatus equipped with a CRT display monitor as a display device and an output device using silver halide photographic paper as an output medium.

In the image recording apparatus 201, a magazine loading section 203 is installed on the left side surface of the main unit 202. An exposure processing section 204 for causing the silver halide photographic paper as an output medium to be exposed to light, and a print creating section 205 for creating a print by developing and drying the exposed silver halide photographic paper are installed inside the main unit 202. The created print is ejected onto the tray 206 mounted on the right side of the main unit 202. Further, a control section 207 is provided on the upward position of the exposure processing section 204 inside the main unit 202.

A CRT 208 is arranged on the top of the main unit 202. It has the function of display means for displaying on the screen the image of the image information to be printed. A film scanner 209 as a transparent document reader is mounted on the left of the CRT 208, and a reflected document input apparatus 210 is arranged on the right.

One of the documents read from the film scanner 209 and reflected document input apparatus 210 is a photosensitive material. The photographic material includes a color negative, color reversal film, black-and-white negative, black-and-white reversal film. Frame image information captured by an analog camera is recorded on the photographic material. The film scanner of the film scanner 209 converts this recorded frame image information into digital image data and creates frame image data. When the photographic material is color paper as silver halide photographic paper, it can be converted into frame image data by the flat head scanner of the reflected document input apparatus 210.

An image reader 214 is mounted where the control section 207 of the main unit 202 is located. The image reader 214 is provided with a PC card adaptor 214a and a floppy (registered trademark) disk adaptor 214b to ensure that a PC card 213a and floppy disk 213b can be inserted into position. The PC card 213a has a memory where multiple items of frame image data obtained by photographing with a digital camera are stored. The floppy disk 213b stores multiple items of frame image data obtained by photographing with a digital camera.

An operation section 211 is arranged forwardly of the CRT 208. This operation section 211 is equipped with an information input section 212, which consists of a touch panel and others.

The recording medium storing the frame image data of the present invention other than the above-mentioned data includes a multimedia card, memory stick, MD data and CD-ROM. The operation section 211, CRT 208, film scanner 209, reflected document input apparatus 210 and image reader 214 is mounted integrally on the main unit 202. Any one of them can be installed as a separate unit.

An image write section 215 is mounted where the control section 207 of the main unit 202 is located. The image write section 215 is equipped with a floppy disk adaptor 215a, MO adaptor 215b, and optical disk adaptor 215c so that an FD 216a, MO 216b and optical disk 216c can be inserted into position, and Image information can be written on the image recording medium.

Further, the control section 207 has means for communication (not illustrated). It receives image data representing the captured image and print instruction directly from another computer in the facilities or a remote computer through the Internet, and is capable of functioning as a so-called network image output apparatus.

### Internal Configuration of Image Recording Apparatus 201

The following describes the internal structure of the image recording apparatus 201:

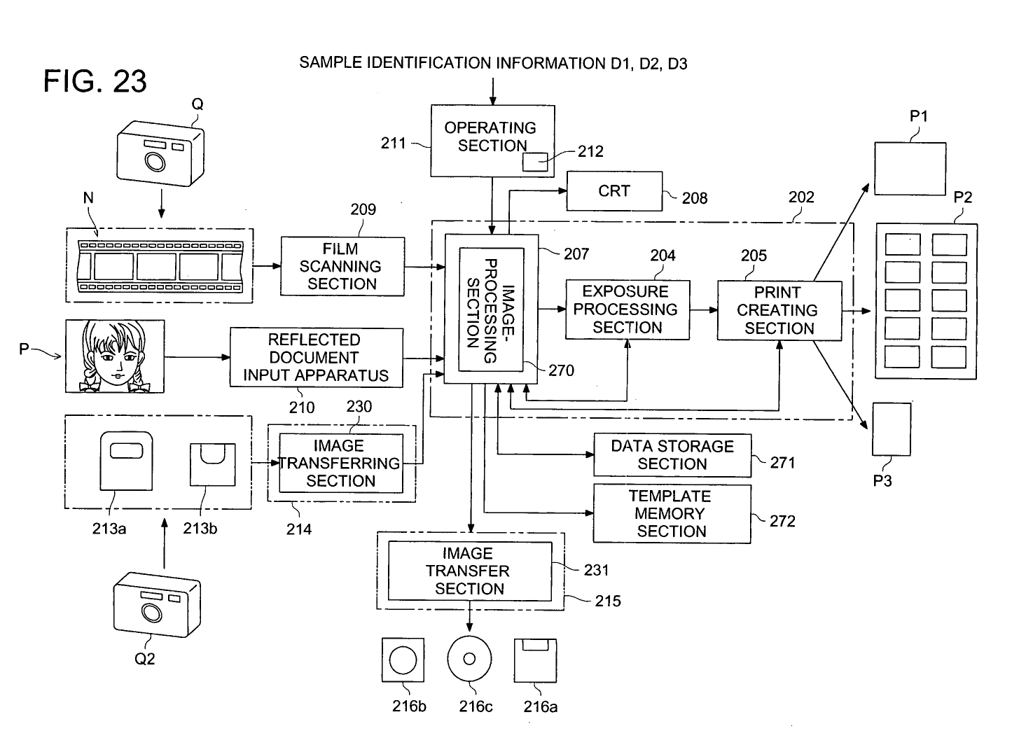

FIG. 23 is a diagram representing the internal configuration of the image recording apparatus 201.

The control section 207 of the image recording apparatus 201 comprises a CPU (Central Processing Unit) and memory section. The CPU reads the various types of control programs stored in the memory section and centrally controls the components constituting the image recording apparatus 201 in conformity to the control program.

The control section 207 has an image processing section 270. Image processing is applied to:

the image data gained by allowing the document image to be read by the film scanner 209 and reflected document input apparatus 210 based on the input signal from the information input means 12 of the operation section 211;

the image data read from the image reader 214; and

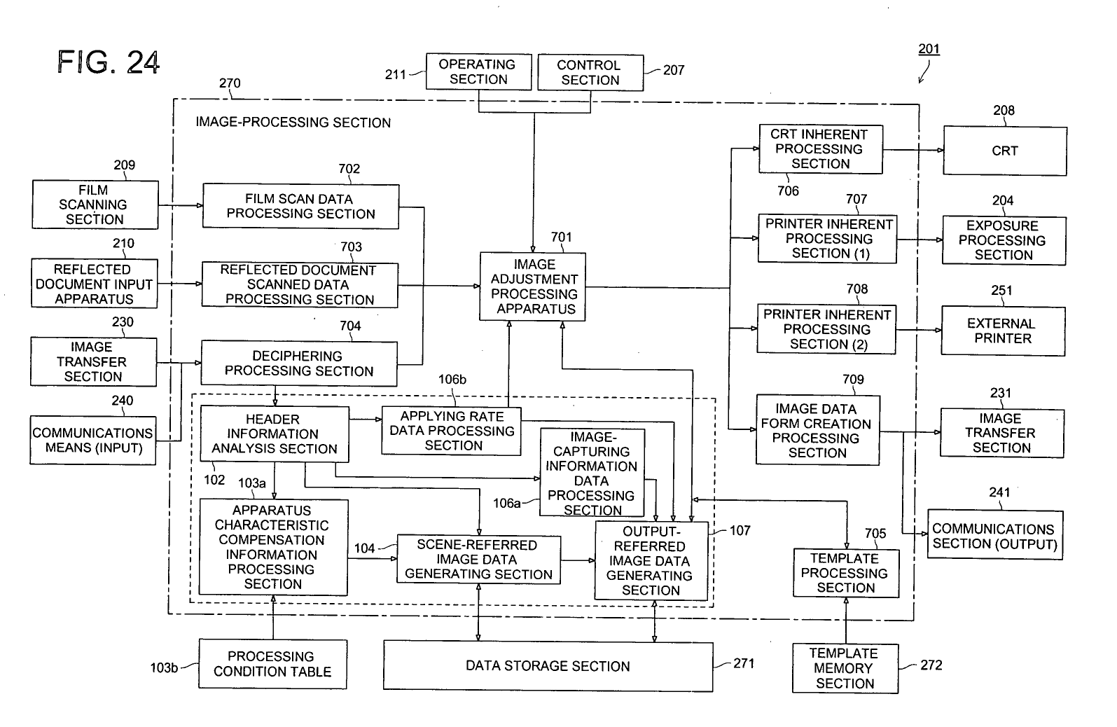

the image data inputted from the external equipment through and communications means (input) 240 (illustrated in FIG. 24). In the image processing apparatus 270, conversion processing in conformity to the output format is applied to the image data subjected to image processing, and the result is output as prints P1, P2 and P3 or by the monitor 208, image write section 215 and communications section (output) 241.

The operation section 211 is provided with an information input section 212. The information input section 212 is constituted by, for instance, a touch panel covering over the display screen of the CRT 208, etc., the depressing signal of the information input section 212 is outputted to the control section 207 as an input signal. It is also possible to arrange such a configuration that the operation section 211 is equipped with a keyboard or mouse.

The film scanner 209 reads the frame image data from the developed negative film N gained by an analog camera. From the reflected document input apparatus 210, the film scanner 209 reads the frame image data from the print P subjected to the processing of development with the frame image printed on the color paper as silver halide photographic paper.

The image reader 214 has a function of reading the frame image data of the PC card 213a and floppy disk 213b photographed and stored by the digital camera. Namely, the image reader 214 is equipped with a PC card adaptor and floppy disk adaptor as image transfer sections 230. It reads the frame image data recorded on the PC card 213a and floppy disk 213b mounted on the floppy disk adaptor 214b, and transfers it to the control section 207. A PC card reader or a PC cad slot, for example, is used as the PC card adaptor 214a.

The data storage section 271 memorizes image information and its corresponding order information (information on the number of prints to be created from the image of a particular frame) and stores them sequentially.

The template memory section 272 memorizes the sample image data (data showing the background image and illustrated image) corresponding to the types of information on sample identification D1, D2 and D3, and memorizes at least one of the data items on the template for setting the composite area with the sample image data. When a predetermined template is selected from among multiple templates previously memorized in the template memory section 272 by the operation by the operator (based on the instruction of a client), the control section 207 performs merging between the frame image information and the selected template. When the types of information on sample identification D1, D2 and D3 have been specified by the operation by the operator (based on the instruction of a client), the sample image data is selected in conformity to the specified types of information on sample identification D1, D2 and D3. Merging of the selected sample image data, image data ordered by a client and/or character data is carried out and, as a result, a print in conformity to the sample image data desired by the client is created. Merging by this template is performed by the widely known chromakey technique.

Sample identification information is not restricted to three types of information on sample identification D1, D2 and D3. More than three types or less than three types can be used. The types of information on sample identification D1, D2 and D3 for specifying the print sample are arranged to be inputted from the operation section 211. Since the types of information on sample identification D1, D2 and D3 are recorded on the sample or order sheet, they can be read by the reading section such as an OCR. Alternatively, they can be inputted by the operator through a keyboard.

As described above, sample image data is recorded in response to sample identification information D1 for specifying the print sample, and the sample identification information D1 for specifying the print sample is inputted. Based on the inputted sample identification information D1, sample image data is selected, and the selected sample image data and image data and/or character data based on the order are merged to create a print according to the specified sample. This procedure allows a user to directly check full-sized samples of various dimensions before placing an order. This permits wide-ranging user requirements to be satisfied.

The first sample identification information D2 for specifying the first sample, and first sample image data are memorized; alternatively, the second sample identification information D3 for specifying the second sample, and second sample image data are memorized. The sample image data selected on the basis of the specified first and second sample identification information D2 and D3, and ordered image data and/or character data are merged with each other, and a print is created according to the specified sample. This procedure allows a greater variety of images to be created, and permits wide-ranging user requirements to be satisfied.

In the exposure processing section 204, the photographic material is exposed and an image is formed thereon in conformity to the output image data generated by image processing of image data by the image processing section 270. This photographic material is sent to the print creating section 205. The print creating section 205 develops ad dries the exposed photographic material to create prints P1, P2 and P3. Print P1 is available in a service size, high-vision size or panorama size. Print P2 is an A4-sized print, print P3 is a business card-sized print (2 in.×3 in.).

Print sizes are not restricted to P1, P2 and P3. Other sized prints can also be used.

The CRT 208 displays the image information inputted from the control section 207.

The image write section 215 is provided with a floppy disk adaptor 215a, MO adaptor 215b, and optical disk adaptor 215c as an image transfer section 231 so that the FD 216a, MO 216b and optical disk 216c can be inserted. This allows the image data to be written on the image recording medium.

Using the communications means (input) 240 (illustrated in FIG. 24), the image processing apparatus 270 receives image data representing the captured image and printing and other work instruction directly from another computer in the facilities or from a remote computer through Internet, and is cable of performing image processing and printing in the remote control mode.

Using the communications means (input) 240 (illustrated in FIG. 24), the image processing apparatus 270 is capable of sending the image data representing the photographed image after image processing of the present invention has been applied, and accompanying order information, to another computer in the facilities or a remote computer through Internet.

As described above, the image recording apparatus 201 comprises:

an input section for capturing the digital image data of various types and image information obtained by dividing the image document and measuring a property of light;

an image processing section for processing the information on the input image captured from this input section in such a way that this image will provide a favorable impression when viewed on the outputting medium;

an image outputting section for displaying or printing out and measuring a property of light, or writing it on the image recording medium;

a communications section (output) for sending the image data and accompanying order information to another computer in the facilities through a communications line or a remote computer through Internet.

### Configuration of Image Processing Apparatus 270

FIG. 24 is a block diagram representing the functional configuration of an image processing apparatus 270 of the present invention. The image data inputted from the film scanner 209 is subjected to calibration inherent to the film scanner, negative/positive reversal of a negative document, removal of dust and scratch, gray balance adjustment, contrast adjustment, removal of granular noise an enhancement of sharpness in the film scan data processing section 702, and is sent to the image adjustment processing section 701. The film size, negative/positive type, information on the major subject recorded optically or magnetically on the film and information on photographing conditions (e.g. information described on the APS) are outputted to the image adjustment processing apparatus 701.

The image data inputted from the reflected document input apparatus 210 is subjected to calibration inherent to a reflected document input apparatus negative/positive reversal of a negative document, removal of dust and scratch, gray balance adjustment, contrast adjustment, removal of granular noise an enhancement of sharpness in the film scan data processing section 702 in the reflected document scanned data processing section 703, and the result is outputted to the image adjustment processing section 701.

The image transfer section 230 and communications means (input) 240 have the function as an input section. Further, the image data inputted from the image transfer section 230 and communications section (input) is subjected to decompression of the compressed symbols or conversion of the color data representation method, as required, according to the form of the data in the image data form deciphering processing section 704. It is converted into the data format suitable for numerical computation inside the image processing section 270 and is outputted to the image adjustment processing apparatus 701. The image data form deciphering processing section 704 determines whether or not the image data of the format according to the image-capturing apparatuses 21 and 22 has been inputted from the image transfer section 230 and communications means (input) 240, and outputs the inputted image data to the header information analysis section 302. The header information analysis section 302 analyzes the image-capturing characteristic compensation data d2, applying rate data d3 and image-capturing information data d4 from the inputted image data.

Designation of the size of output image is inputted from the operation section 211. Further, if there is designation of the size of the output image sent to the communications means (input) 240 or the output image embedded in the header/tag information of the image data obtained through the image transfer section 230, the image data form deciphering processing section 704 detects the information and sends it to the image adjustment processing apparatus 701.

The image-capturing characteristic compensation data d2, analyzed by the header information analysis section 102, are outputted to apparatus characteristic compensation information processing section 103a, which determines the image-processing conditions, based on the processing condition table 103b. The determined image-processing conditions are applied to the image data in the scene-referred image data generating section 104 having a function of the “scene-referred image data generating means”, to generate scene-referred image data d5.

The image-capturing information data d4 analyzed by the header information analysis section 102 is outputted to image-capturing information data processing section 106a, to determine the image processing conditions in regard to the generating operation for output-referred image data d6.

The applying rate data d3, analyzed by the header information analysis section 102, are outputted to applying rate data processing section 106b, which determines the conditions for the white-balance adjustment.

Based on the instruction from the operation section 211 and control section 207, the image adjustment processing apparatus 701 transfers the image processing conditions to the output-referred image data generating section 107, which creates the output-referred image data d6 suitable for the device and outputting medium at the output destination.

The output-referred image data generating section 107, having the function of the “output-referred image data generating means”, generates output-referred image data d6 from scene-referred image data d5, based on the image-processing conditions determined by the image-capturing information data processing section 106a, the conditions of the white-balance adjustment determined by the applying rate data processing section 106b and the other image-processing conditions transmitted from the image adjustment processing apparatus 701. FIG. 9 shows a detailed configuration of output-referred image data generating section 107, and FIG. 11 shows a procedure flowchart of generating output-referred image data d6 from scene-referred image data d5. Since the explanations with respect to FIG. 9 and FIG. 11 are the same as those for the image-processing apparatus 115 in the foregoing, such the explanations will be omitted. Otherwise, the other detailed configuration of the output-referred image data generating section 107 is shown in FIG. 16, and the other procedure flowchart of generating output-referred image data d6 from scene-referred image data d5 is shown in FIG. 17. Since the explanations with respect to FIG. 16 and FIG. 17 are the same as those for the image-processing apparatus 115 in the foregoing, such the explanations will be omitted.

The image adjustment processing apparatus 701 calls a predetermined image data (template) from the template memory section 272 when template processing is required. Image data is sent to the template processing section 705. It is merged with the template, and the image data subsequent to template processing is again received. In response to the instruction from the operation section 211 and control section 207, the image adjustment processing apparatus 701 applies image processing to the image data received from the film scanner 209, image transfer section 230, communications means (input) 240 and template processing section 705, in such a way that the image will provide a favorable impression when viewed on the outputting medium. Then, the adjustment for each of the sections included in the image-processing section 270 is conducted so as to generate the digital image data to be outputted, and the digital image data are sent to the CRT inherent processing section 706, printer inherent processing section (1) 707, image data form creation processing section 709 and data storage section 271.

The CRT inherent processing section 706 applies processing of changing the number of pixels or color matching to the image data received from the image adjustment processing apparatus 701, as required. Then the image data for display merged with the information requiring control information, etc. is sent to the CRT 208. The printer inherent processing section (1) 707 provides processing of printer inherent calibration, color matching and change in the number of pixels, as required, and sends image data to the exposure processing section. When an external printer 251 such as a large-format inkjet printer is to be connected to the image recording apparatus 201, a printer inherent processing section (2) 708 is provided for each printer to be connected, so that adequate printer inherent calibration, color matching, change in the number of pixels and other processing can be carried out.

The image data form creation processing section 709 converts the image data received from the image adjustment processing apparatus 701, into various types of general-purpose image format represented by JPEG, TIFF and Exif as required. Then the image data is sent to the image transfer section 231 and communications means (input) 241.

The image data created by the output-referred image data generating section 107 assumes processing by the CRT inherent processing section 706, printer inherent processing section (1) 707, printer inherent processing section (2) 708 and image data form creation processing section 709. The image data form creation processing section 709 attaches to this image data the status file identifying the optimized image data for CRT, exposure output section, external printer, communications means (output) and others, based on output-referred image data d5, and sends the resultant image data separately to the image transfer section.

The above-mentioned division into the film scan data processing section 702, reflected document scanned data processing section 703, image data form deciphering processing section 704, image adjustment processing apparatus 701, CRT inherent processing section 706, printer inherent processing section (1) 707, printer inherent processing section (2) 708 and image data form creation processing section 709 is assumed to assist understanding of the functions of the image processing section 270. They need not necessarily be realized as physically independent devices. For example, they can be realized in the form of a division of the type of software processing in a single CPU.

Further, the divisions in the image processing section 270, such as, for instance, the header information analysis section 102, apparatus characteristic compensation information processing section 103a, image-capturing information data processing section 106a, applying rate data processing section 106b, scene-referred image data generating section 104 and output-referred image data generating section 107, are assumed to assist understanding of the functions of the image processing section 270 of the present invention. Therefore, they need not necessarily be realized as physically independent devices. For example, they can be realized in the form of a division of the type of software processing in a single CPU.

### Operation of Image Processing Section 270

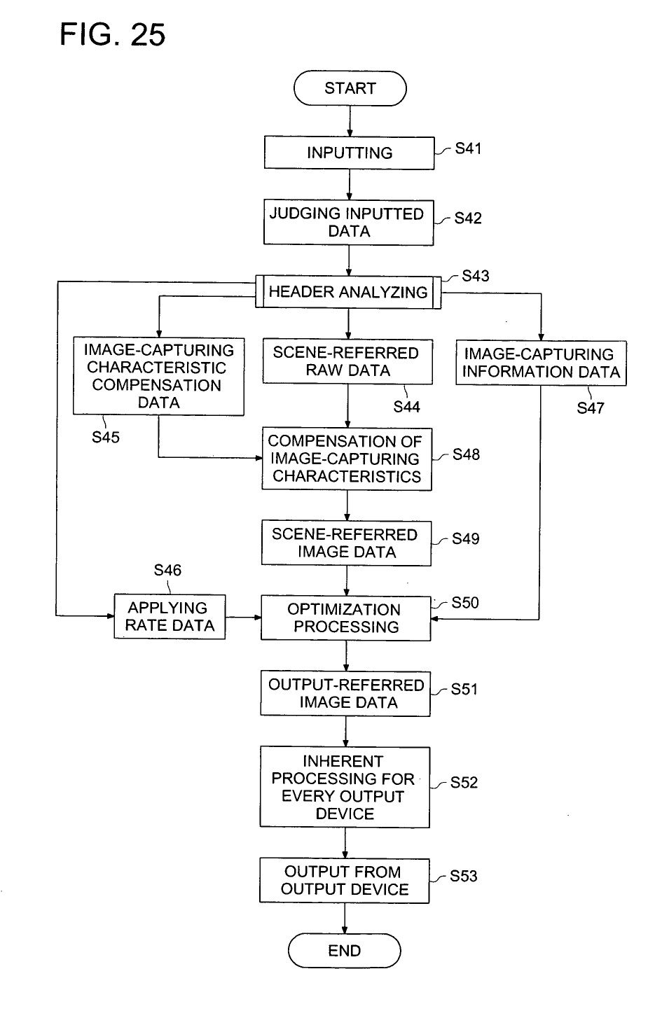

FIG. 25 is a flowchart representing image data formation processing to be carried out by interconnection among various parts of the image recording apparatus 201. Referring to drawings, the following describes the operations of each portion of the image processing section 270:

Data is inputted from the image transfer section 230 or communications means (input) 240 to the image processing section 270 (Step S41). When the image data form deciphering processing section 704 has identified this inputted data as the digital image data file by the above-mentioned image-capturing apparatus 22 or 23 (Step S42), the contents of the inputted digital image data file are analyzed by the header information analysis section 102 (Step S43), and the file is divvied into those for scene-referred raw data d1 (Step S44), image-capturing characteristic compensation data d2 (Step S45), applying rate data d3 (Step S46) and image-capturing information data d4 (Step S47).

The image-capturing characteristic compensation data d2 is outputted to the apparatus characteristic compensation processing section 103a, and processing conditions for generating scene-referred image data d5 are determined by the apparatus characteristic compensation processing section 103a referencing the processing condition table 103b. The scene-referred raw data d1 is outputted to the scene-referred image data generating section 104, and image-capturing characteristic compensation processing is carried out according to the processing conditions determined by the apparatus characteristic compensation processing section 103a (Step S48). Then scene-referred image data d5 is generated and is outputted to the output-referred image data generating section 107 (Step S49).

The image-capturing information data d4 is outputted to the image-capturing information data processing section 106a, and processing conditions for generating the output-referred image data d6 in response to image-capturing conditions are determined by the image-capturing information data processing section 106a on the basis of the image-capturing information data d4. The applying rate data d3 is outputted to the applying rate data processing section 106b, and the conditions for the white-balance adjustment are determined on the basis of the applying rate data d3. Further, image processing conditions for generating the output-referred image data d6 suited to the outputting device and outputting medium are determined by the image adjustment processing apparatus 701, based on the instructions from the operation section 211 and control section 207. Optimization processing is applied to the scene-referred image data d5 having been inputted from the scene-referred image data generating section 104 by the output-referred image data generating section 107 in conformity to the processing conditions determined by the image-capturing information data processing section 106a, the conditions for the white-balance adjustment determined by the applying rate data processing section 106b and the processing conditions determined by the image adjustment processing apparatus 701 (Step S50). Output-referred image data d6 is generated and is outputted to any one of the CRT inherent processing section 706, printer inherent processing section (1) 707, printer inherent processing section (2) 708 and image data form creation processing section 709 in conformity to the output destination (Step S51). In the processing section where the data is outputted, output-referred image data d6 is subjected to processing inherent to the output destination (Step S52), and is outputted from the output destination specified by the operation section 211 (Step S53).

As described in the above, the image recording apparatus 201 of the present invention allows the scene-referred raw data d1 outputted by the image-capturing apparatus 22 or 23 to generate the optimized output-referred image data d6, without losing the captured image information, thereby ensuring quick formation of an output-referred image on such a display device as CRT, liquid crystal display and plasma display or on such an outputting medium as paper for hard copy image generation including silver halide photographic paper, inkjet paper and thermal printing paper.

Incidentally, the file including scene-referred image data d5 attached with applying rate data d3 and image-capturing information data d4 can be inputted into the image transferring section 214. In this case, the processing operations to be conducted in the apparatus characteristic compensation information processing section 103a and the scene-referred image data generating section 104 are omitted, and only the optimization processing including the white-balance adjustment is applied to scene-referred image data d5.

Incidentally, when implementing the present invention, a method for adjusting the white-balance and a configuration of the output-referred image data generating section 107 for implementing the method are not limited to the abovementioned methods and configurations. Further, it would be an applicable specification that the image-recording apparatus 201 can change the white-balance adjusting method to employ it. Still further, as shown in FIG. 19, it is also applicable that a white-balance applying-rate inputting screen 2081 is displayed on the CRT 208 under the controlling actions of control section 207, so that the white-balance adjustment is applied, based on the applying rate inputted from the above screen. Accordingly, it becomes possible for the image-processing operator to apply the white-balance adjustment corresponding to the tastes of him or a client. Still further, as shown in FIG. 19, it would be also an applicable specification that the result of the light source estimation and the result of the white-balance adjustment based on applying rate data are displayed on the CRT 208.

Further, by converting the image-processing procedure to be performed in the image-processing apparatus 115 and the image-recording apparatus 201 into a computer program, and by storing the computer program into the recording medium, it becomes possible to execute the technical features of the present invention in other hardware, such as, for instance, the conventional image-processing apparatus and the conventional image-recording apparatus.

As described in the foregoing, according to the present invention, the following effects can be attained.

(1) The image-capturing apparatus of the present invention makes it possible to output: scene-referred raw data d2 as an direct raw output signal of the image-capturing apparatus faithfully recording the information of a subject, wherein there is omission of image processing of intentionally modifying the contents of data to improve the effect in viewing the image such as conversion of gradation, and enhancement of sharpness and color saturation, and the processing of mapping signal enhancement of each color channel based on the spectral sensitivity inherent to the image-capturing device, into the above-mentioned standardized color space such as RIMM RGB and sRGB; and the sufficient data for carrying out image-capturing characteristic compensation processing wherein the spectral sensitivity inherent to the image-capturing device or the matrix coefficient to be used for conversion into the standardized color space such as RIMM RGB and sRGB are written. At the same time, the above-mentioned image-capturing apparatus 21 omits processing of conversion into the scene-referred image data in the image-capturing apparatus, thereby reducing the processing load and power consumption of the image-capturing apparatus, improving the processing (photographing) capability and increasing the number of sheets to be processed (shot) in the battery mode.

(2) The image processing apparatus of the present invention allows the scene-referred image data to be generated from the scene-referred raw data outputted from the image-capturing apparatus, and creates the optimized output-referred image data, without the image-capturing information being lost, so that it is outputted to the onto such a display device as CRT, liquid crystal display and plasma display, and a storage medium of any known type such as paper for generation of hardcopy images including silver halide photographic paper, inkjet paper and thermal printing paper.

(3) The image recording apparatus of the present invention allows the scene-referred image data to be generated from the scene-referred raw data outputted from the image-capturing apparatus, and ensures ensuring quick formation of an output-referred image on such a display device as CRT, liquid crystal display and plasma display or on such an outputting medium as paper for hard copy image generation including silver halide photographic paper, inkjet paper and thermal printing paper, wherein the optimized output-referred image data is retained, without the captured image information being lost.

(4) The image-capturing apparatus, the image-processing apparatus, the image-recording apparatus and the image-processing method for the same, embodied in the present invention, make it possible to select an favorable color finishing of the image having a scene captured under various light sources, such as a sunset light, a tungsten light, a candle light, etc., from a color tone just same as viewer's sight, a color tone under the daylight, etc., corresponding to not only tastes of the photographer at the time of capturing the image, but also tastes of the photographer after the time of capturing the image, the person who creates its print and the viewer of the image, without generating the deterioration of the image quality, caused by the image compression processing.

(5) The program for executing the image-processing method of the present invention and the recording medium storing the program make it possible to execute the technical features of the present invention in other hardware, such as, for instance, the conventional image-processing apparatus and the conventional image-recording apparatus.

Disclosed embodiment can be varied by a skilled person without departing from the spirit and scope of the invention.

What is claimed is:

1. An apparatus for capturing an image, comprising:
a scene-referred raw data generating section to generate scene-referred raw data, which directly represent said image while depending on image-capturing characteristics of said apparatus;
a reproduction-auxiliary data generating section to generate reproduction-auxiliary data, based on which an image-capturing characteristic compensation processing is to be applied to said scene-referred raw data generated by said scene-referred raw data generating section, so as to generate scene-referred image data in a standardized format from said scene-referred raw data;
a designating section to designate a degree of white-balance adjustment; and
a storage controlling section to attach said reproduction-auxiliary data and white-balance data indicating said degree of said white-balance adjustment to said scene-referred raw data in order to store all of them into a storage medium.

2. The apparatus of claim 1, further comprising:
an image-capturing data generating section to generate image-capturing data, which represent image-capturing conditions established at a time of capturing said image;
wherein said storage controlling section attaches said reproduction-auxiliary data, said white-balance data and said image-capturing data to said scene-referred raw data in order to store all of them into said storage medium.

3. The apparatus of claim 1,
wherein said image-capturing data includes a photographing EV value established at a time of capturing said image.

4. An apparatus for processing data, comprising:
a receiving section to receive scene-referred raw data, which directly represent an image captured by an image-capturing apparatus while depending on image-capturing characteristics of said image-capturing apparatus, and to receive reproduction-auxiliary data in respect to said scene-referred raw data, and to receive white-balance data indicating a degree of white-balance adjustment;
a scene-referred image data generating section to generate scene-referred image data from said scene-referred raw data received by said receiving section, based on said reproduction-auxiliary data received by said receiving section, by applying an image-capturing characteristic compensation processing to said scene-referred raw data; and
an output data generating section to generate output data by attaching said white-balance data to said scene-referred image data.

5. The apparatus of claim 4,
wherein said scene-referred image data are generated in a standardized format from said scene-referred raw data.

6. The apparatus of claim 4,
wherein said receiving section also receives image-capturing data, which represent image-capturing conditions established at a time of capturing said image; and
wherein said output data generating section generates said output data by attaching said white-balance data and said image-capturing data to said scene-referred image data.

7. The apparatus of claim 5, further comprising:
an output-referred image data generating section to generate output-referred image data, based on which a reproduced image is formed on an outputting medium, by applying an image-processing for optimizing said reproduced image to said scene-referred image data generated by said scene-referred image data generating section;
wherein contents of said image-processing are determined on the basis of said white-balance data received by said receiving section.

8. The apparatus of claim 6, further comprising:
an output-referred image data generating section to generate output-referred image data, based on which a reproduced image is formed on an outputting medium, by applying an image-processing for optimizing said reproduced image to said scene-referred image data generated by said scene-referred image data generating section;
wherein contents of said image-processing are determined on the basis of said white-balance data and said image-capturing data, both received by said receiving section.

9. The apparatus of claim 4,
wherein said receiving section receives a photographing EV value established at a time of capturing said image.

10. The apparatus of claim 7, further comprising:
an applying amount determining section to determine an applying amount of said white-balance adjustment to be applied to said scene-referred image data, based on said white-balance data indicating said degree of said white-balance adjustment;
wherein said output-referred image data generating section includes:
a white-balance adjusting section to apply said applying amount of said white-balance adjustment, determined by said applying amount determining section, to said scene-referred image data.

11. The apparatus of claim 10,
wherein said white-balance adjusting section is provided with an image area dividing function for dividing a whole image area of said scene-referred image data into a plurality of small image areas.

12. The apparatus of claim 11,
wherein said white-balance adjusting section is further provided with a ratio calculating function for calculating a R/G ratio and a B/G ratio for a respective one of said plurality of small image areas, divided by said image area dividing function; and
wherein said R/G ratio represents a ratio between an integrated value of R (Red) signals and another integrated value of G (Green) signals within each of said plurality of small image areas, while said B/G ratio represents a ratio between an integrated value of B (Blue) signals and another integrated value of G (Green) signals within each of said plurality of small image areas.

13. The apparatus of claim 12,
wherein said white-balance adjusting section is further provided with a light-source estimating function for estimating a kind of a photographic light source for a respective one of said plurality of small image areas, by plotting said R/G ratio and said B/G ratio, calculated by said ratio calculating function, onto a light-source estimating map in which light-source area frames, indicating ranges of various combinations of said R/G ratio and said B/G ratio corresponding to various kinds of light-sources.

14. The apparatus of claim 13,
wherein said white-balance adjusting section is further provided with a light-source determining function for determining a kind of a photographic light source under which said scene-referred image data are acquired by employing a number of small image areas plotted within one of said light-source area frames, or a membership function in which a photographic EV value is a variable.

15. The apparatus of claim 11,
wherein said white-balance adjusting section is further provided with a color-temperature estimating function for estimating a color temperature of a photographic light source for a respective one of said plurality of small image areas by employing a least squares method.

16. The apparatus of claim 15,
wherein said white-balance adjusting section is further provided with a histogram creating function for creating a histogram based on an emerging frequency of said color temperature of said photographic light source for a respective one of said plurality of small image areas.

17. The apparatus of claim 16,
wherein said white-balance adjusting section is further provided with a group-wise white-balance adjusting function for dividing said whole image area of said scene-referred image data into plural groups, based on said histogram created by said histogram creating function, so as to apply a different white-balance adjustment to a respective one of said plural groups, said different white-balance adjustment is one of various white-balance adjustments being different relative to each other corresponding to a respective one of said plural groups.

18. The apparatus of claim 10,
wherein said applying amount determining section can arbitrarily establish a relationship between said white-balance data, indicating said degree of said white-balance adjustment, and an applying amount of said white-balance adjustment to be applied in practice.

19. An apparatus for outputting a reproduced image onto an outputting medium, comprising:
a receiving section to receive scene-referred raw data, which directly represent an image captured by an image-capturing apparatus while depending on image-capturing characteristics of said image-capturing apparatus, and to receive reproduction-auxiliary data in respect to said scene-referred raw data, and to receive white-balance data indicating a degree of white-balance adjustment;
a scene-referred image data generating section to generate scene-referred image data from said scene-referred raw data received by said receiving section, based on said reproduction-auxiliary data received by said receiving section, by applying an image-capturing characteristic compensation processing to said scene-referred raw data;
an output-referred image data generating section to generate output-referred image data, based on which a reproduced image is formed on an outputting medium, by applying an image-processing for optimizing an image quality of said reproduced image to said scene-referred image data generated by said scene-referred image data generating section; and
an image-forming section to form said reproduced image on said outputting medium, based on said output-referred image data;
wherein contents of said image-processing for optimizing said image quality of said reproduced image are determined on the basis of said white-balance data indicating said degree of white-balance adjustment.

20. The apparatus of claim 19,
wherein said scene-referred image data are generated in a standardized format from said scene-referred raw data.

21. The apparatus of claim 19,
wherein said receiving section also receives image-capturing data, which represent image-capturing conditions established at a time of capturing said image.

22. The apparatus of claim 19,
wherein said receiving section receives a photographing EV value established at a time of capturing said image.

23. The apparatus of claim 19, further comprising:
an applying amount determining section to determine an applying amount of said white-balance adjustment to be applied to said scene-referred image data, based on said white-balance data indicating said degree of said white-balance adjustment;
wherein said output-referred image data generating section includes:
a white-balance adjusting section to apply said applying amount of said white-balance adjustment, determined by said applying amount determining section, to said scene-referred image data.

24. The apparatus of claim 23,
wherein said white-balance adjusting section is provided with an image area dividing function for dividing a whole image area of said scene-referred image data into a plurality of small image areas.

25. The apparatus of claim 24,
wherein said white-balance adjusting section is further provided with a ratio calculating function for calculating a R/G ratio and a B/G ratio for a respective one of said plurality of small image areas, divided by said image area dividing function; and
wherein said R/G ratio represents a ratio between an integrated value of R (Red) signals and another integrated value of G (Green) signals within each of said plurality of small image areas, while said B/G ratio represents a ratio between an integrated value of B (Blue) signals and another integrated value of G (Green) signals within each of said plurality of small image areas.

26. The apparatus of claim 25,
wherein said white-balance adjusting section is further provided with a light-source estimating function for estimating a kind of a photographic light source for a respective one of said plurality of small image areas, by plotting said R/G ratio and said B/G ratio, calculated by said ratio calculating function, onto a light-source estimating map in which light-source area frames, indicating ranges of various combinations of said R/G ratio and said B/G ratio corresponding to various kinds of light-sources.

27. The apparatus of claim 26,
wherein said white-balance adjusting section is further provided with a light-source determining function for determining a kind of a photographic light source under which said scene-referred image data are acquired by employing a number of small image areas plotted within one of said light-source area frames, or a membership function in which a photographic EV value is a variable.

28. The apparatus of claim 24,
wherein said white-balance adjusting section is further provided with a color-temperature estimating function for estimating a color temperature of a photographic light source for a respective one of said plurality of small image areas by employing a least squares method.

29. The apparatus of claim 28,
wherein said white-balance adjusting section is further provided with a histogram creating function for creating a histogram based on an emerging frequency of said color temperature of said photographic light source for a respective one of said plurality of small image areas.

30. The apparatus of claim 29,
wherein said white-balance adjusting section is further provided with a group-wise white-balance adjusting function for dividing said whole image area of said scene-referred image data into plural groups, based on said histogram created by said histogram creating function, so as to apply a different white-balance adjustment to a respective one of said plural groups, said different white-balance adjustment is one of various white-balance adjustments being different relative to each other corresponding to a respective one of said plural groups.

31. The apparatus of claim 23,
wherein said applying amount determining section can arbitrarily establish a relationship between said white-balance data, indicating said degree of said white-balance adjustment, and an applying amount of said white-balance adjustment to be applied in practice.

32. A method for processing data, comprising the steps of:
applying an image-capturing characteristic compensation processing to scene-referred raw data, which directly represent an image captured by an image-capturing apparatus while depending on image-capturing characteristics of said image-capturing apparatus, based on reproduction-auxiliary data in respect to said scene-referred raw data, in order to generate scene-referred image data from said scene-referred raw data; and
generating output-referred image data, based on which a reproduced image is formed on an outputting medium, by applying an image-processing for optimizing an image quality of said reproduced image to said scene-referred image data generated in said applying step;
wherein contents of said image-processing for optimizing said image quality of said reproduced image are determined on the basis of white-balance data indicating a degree of white-balance adjustment.

33. The method of claim 32,
wherein said scene-referred image data are generated in a standardized format from said scene-referred raw data.

34. The method of claim 32,
wherein said contents of said image-processing for optimizing said image quality of said reproduced image are determined on the basis of said white-balance data indicating said degree of white-balance adjustment and image-capturing data representing image-capturing conditions established at a time of capturing said image.

35. The method of claim 32, further comprising the steps of:
determining an applying amount of said white-balance adjustment to be applied to said scene-referred image data, based on said white-balance data indicating said degree of said white-balance adjustment; and
applying said applying amount of said white-balance adjustment, determined in said determining step, to said scene-referred image data.

36. The method of claim 35, further comprising the step of:
dividing a whole image area of said scene-referred image data into a plurality of small image areas.

37. The method of claim 36, further comprising the step of:
calculating a R/G ratio and a B/G ratio for a respective one of said plurality of small image areas, divided in said dividing step;
wherein said R/G ratio represents a ratio between an integrated value of R (Red) signals and another integrated value of G (Green) signals within each of said plurality of small image areas, while said B/G ratio represents a ratio between an integrated value of B (Blue) signals and another integrated value of G (Green) signals within each of said plurality of small image areas.

38. The method of claim 37, further comprising the step of:
estimating a kind of a photographic light source for a respective one of said plurality of small image areas, by plotting said R/G ratio and said B/G ratio, calculated in said calculating step, onto a light-source estimating map in which light-source area frames, indicating ranges of various combinations of said R/G ratio and said B/G ratio corresponding to various kinds of light-sources.

39. The method of claim 38, further comprising the step of:
determining a kind of a photographic light source under which said scene-referred image data are acquired by employing a number of small image areas plotted within one of said light-source area frames, or a membership function in which a photographic EV value is a variable.

40. The method of claim 36, further comprising the step of:
estimating a color temperature of a photographic light source for a respective one of said plurality of small image areas by employing a least squares method.

41. The method of claim 40, further comprising the step of:
creating a histogram based on an emerging frequency of said color temperature of said photographic light source for a respective one of said plurality of small image areas.

42. The method of claim 41, further comprising the step of:
dividing said whole image area of said scene-referred image data into plural groups, based on said histogram created in said creating step, so as to apply a different white-balance adjustment to a respective one of said plural groups, said different white-balance adjustment is one of various white-balance adjustments being different relative to each other corresponding to a respective one of said plural groups.

43. The method of claim 35,
wherein a relationship between said white-balance data indicating said degree of said white-balance adjustment and an applying amount of said white-balance adjustment to be applied in practice can be arbitrarily established in said determining step for determining said applying amount of said white-balance adjustment.

44. The method of claim 32, further comprising the step of:
receiving a photographing EV value established at a time of capturing said image.

45. A computer program for executing data processing operations, comprising the functional steps of:
applying an image-capturing characteristic compensation processing to scene-referred raw data, which directly represent an image captured by an image-capturing apparatus while depending on image-capturing characteristics of said image-capturing apparatus, based on reproduction-auxiliary data in respect to said scene-referred raw data, in order to generate scene-referred image data from said scene-referred raw data; and
generating output-referred image data, based on which a reproduced image is formed on an outputting medium, by applying an image-processing for optimizing an image quality of said reproduced image to said scene-referred image data generated in said applying step;
wherein contents of said image-processing for optimizing said image quality of said reproduced image are determined on the basis of white-balance data indicating a degree of white-balance adjustment.

46. A recording medium that stores a computer program for executing data processing operations,
wherein said computer program comprises the functional steps of:
applying an image-capturing characteristic compensation processing to scene-referred raw data, which directly represent an image captured by an image-capturing apparatus while depending on image-capturing characteristics of said image-capturing apparatus, based on reproduction-auxiliary data in respect to said scene-referred raw data, in order to generate scene-referred image data from said scene-referred raw data; and
generating output-referred image data, based on which a reproduced image is formed on an outputting medium, by applying an image-processing for optimizing an image quality of said reproduced image to said scene-referred image data generated in said applying step; and
wherein contents of said image-processing for optimizing said image quality of said reproduced image are determined on the basis of white-balance data indicating a degree of white-balance adjustment.
